(19) United States
(12) Patent Application Publication
(10) Pub. No.: US 2025/0357629 A1
(43) Pub. Date: Nov. 20, 2025

(54) Betaine-Induced Hierarchical Sepiolite Membranes for Energy Storage

(71) Applicant: University of Central Florida Research Foundation, Inc., Orlando, FL (US)

(72) Inventors: Kausik Mukhopadhyay, Orlando, FL (US); Priyanka Makkar, Orlando, FL (US); Md Roxy Islam, Orlando, FL (US)

(21) Appl. No.: 19/197,420

(22) Filed: May 2, 2025

Related U.S. Application Data
(60) Provisional application No. 63/648,228, filed on May 16, 2024.
(60) Provisional application No. 63/766,734, filed on Mar. 4, 2025.

(51) Int. Cl. H01M 50/446; H01G 11/52; H01M 8/0236; H01M 8/0243; H01M 10/0525; H01M 50/403; H01M 50/411; H01M 50/434; H01M 50/489

(52) U.S. Cl. CPC H01M 50/446; H01G 11/52; H01M 8/0236; H01M 8/0243; H01M 10/0525; H01M 50/403; H01M 50/411; H01M 50/434; H01M 50/489

(57) ABSTRACT

An environmentally sustainable, biodegradable, zwitterion-functionalized sepiolite clay composite membrane suitable for electrochemical energy storage and conversion devices is disclosed. The membrane is synthesized by dispersing naturally abundant sepiolite clay in water, functionalizing the slurry with zwitterions such as betaine, alanine, arginine, proline, or valine, and vacuum drying at ambient temperature to yield a free-standing, flexible composite membrane. The zwitterionic compounds chemically attach to surface silanol sites of sepiolite fibers, partially disaggregating fiber bundles and creating controlled hierarchical porosity. Substantially free of polymeric binders, metals, and carbonaceous materials, these membranes exhibit improved ionic conductivity, thermal stability, and chemical resistance compared to traditional separators. They provide ionic conduction and electrical insulation as separators in lithium-ion batteries, sodium-ion batteries, supercapacitors, and fuel cells, thus addressing critical performance, sustainability, and safety requirements in energy storage technologies.

### PRIORITY CLAIM

This application claims priority to U.S. Provisional Patent Application 63/648,228 filed May 16, 2024 and entitled “Betaine Induced Hierarchical Sepiolite Nano Assemblies” and U.S. Provisional Patent Application 63/766,734 filed Mar. 4, 2025 and entitled “Hybrid Zwitterion-Modified Sepiolite Clay Membranes for Energy Storage Applications.”

### FEDERALLY SPONSORED RESEARCH OR DEVELOPMENT

This invention was made with Government support under Grant No. EMW-2021-FP-00567 awarded by the United States Department of Homeland Security. The government has certain rights in the invention.

### BACKGROUND OF THE INVENTION

### 1. Field of the Invention

The described embodiments relate generally to materials science and electrochemical engineering. Specifically, the described embodiments relate to systems and methods for developing bio-friendly, sustainable, cost-effective, and commercially viable hybrid zwitterion-modified sepiolite clay composite membranes using zwitterions such as betaine (trimethylglycine), alanine, arginine, proline, and valine. These membranes are synthesized without polymers, metals, or carbon-based precursors and exhibit enhanced ionic conductivity, flexibility, mechanical durability, and exceptional thermal and chemical stability. The described membranes are intended for use in energy storage and conversion devices, including but not limited to lithium-ion and sodium-ion battery separators, supercapacitors, and fuel cells.

### 2. Brief Description of the Related Art

Lithium-ion batteries currently dominate energy storage solutions due to their high energy density, long cycle life, and extensive applicability across various industries, including consumer electronics, automotive, aerospace, and renewable energy storage systems. However, the proliferation of lithium-ion technology is significantly constrained by several critical limitations. A prominent issue is the reliance on expensive and environmentally harmful raw materials such as cobalt, nickel, and lithium. These materials are subject to geopolitical tensions and scarcity concerns, further exacerbating price volatility and supply chain vulnerabilities. Additionally, the extraction processes for these raw materials, such as lithium mining and cobalt refining, pose significant environmental risks due to potential contamination of water resources, substantial energy consumption, and associated greenhouse gas emissions.

Another notable challenge lies in the manufacturing complexity and cost of current membrane materials and electrolytes used in energy storage technologies. Traditional ion-conducting membranes and separators in lithium-ion batteries, fuel cells, and supercapacitors predominantly utilize polymer-based materials like polyethylene (PE), polypropylene (PP), polyvinylidene fluoride (PVDF), and other synthetic polymers. The production of these polymer-based membranes typically involves complex processes, including solvent casting, melt extrusion, and electrospinning, often requiring the use of hazardous organic solvents and stringent processing conditions. These conditions not only drive up production costs but also pose serious environmental and occupational hazards, requiring strict controls and expensive waste management practices.

Polymeric membranes, although widely used, exhibit inherent limitations concerning thermal stability, chemical resistance, and mechanical integrity under harsh operating conditions. For example, polyethylene and polypropylene membranes, while commonly employed as battery separators, have melting temperatures that pose significant safety risks, particularly under thermal runaway conditions experienced during rapid charging, discharging, or external thermal events. The thermal instability of polymer separators contributes to performance degradation, safety hazards, and diminished cycle life, especially in high-power and high-temperature applications such as electric vehicles and grid-scale storage.

Chemical instability further exacerbates these issues, particularly in highly reactive electrolyte environments or in the presence of organic solvents commonly used in lithium-ion batteries. Polymeric membranes often degrade chemically over prolonged cycles, leading to structural weakening, increased internal resistance, and eventual device failure. Additionally, these synthetic polymer-based materials frequently require complex fabrication methods involving hazardous organic solvents, strong acids, or alkaline solutions. The use of these chemicals complicates manufacturing, escalates costs, and raises significant environmental concerns due to challenges associated with solvent recovery, waste disposal, and potential toxic emissions.

Another significant concern with existing polymeric membranes and electrolytes is their poor recyclability and biodegradability. End-of-life management for battery separators and polymer electrolytes is challenging due to their persistent environmental impact. Disposal of spent polymer membranes often results in environmental contamination, contributing to the accumulation of persistent waste. Given the increasing emphasis on circular economy principles and stringent environmental regulations globally, there is a critical and growing industry need for sustainable, biodegradable, and recyclable membrane materials that reduce ecological footprint.

Furthermore, contemporary research into alternative membrane materials, such as ceramics, glass fibers, and composite separators, has shown potential but presents its own set of challenges. Ceramic separators, despite excellent thermal stability and good chemical resistance, typically suffer from brittleness and mechanical fragility. Such brittleness can lead to mechanical failure under operational stress, limiting their practical deployment in flexible or deformable applications. Ceramic-based membranes, although offering superior thermal properties, often incur substantially higher production costs and complexity, making them less attractive for widespread adoption in cost-sensitive markets.

The need for advanced membranes also extends beyond lithium-ion batteries to emerging technologies such as sodium-ion batteries, redox flow batteries, and supercapacitors. Sodium-ion batteries, for example, are promising as low-cost alternatives to lithium-ion technologies but require stable, robust membrane materials capable of accommodating different electrochemical and ionic transport properties. Similarly, redox flow batteries demand membranes with high chemical stability and permeability characteristics to ensure efficient and prolonged operational performance.

The current landscape also emphasizes energy storage technologies capable of supporting high-temperature operation, particularly for applications in automotive, aerospace, and industrial sectors. However, the thermal instability of many existing membrane materials limits their use in these demanding conditions. Polymer-based membranes typically soften or degrade at elevated temperatures, causing irreversible loss of function and potential safety hazards. As a result, there is significant market demand for membrane technologies with intrinsic thermal robustness, chemical durability, and consistent electrochemical performance across broad temperature ranges.

Moreover, ion-conducting membranes must exhibit ionic conductivity to maintain efficiency and performance, particularly at lower electrolyte concentrations or in non-aqueous environments. Current polymeric separators often exhibit relatively low ionic conductivities, necessitating thin membranes or complex microstructures to achieve adequate performance. This constraint complicates the manufacturing process, reduces mechanical robustness, and limits device durability, especially over extended cycles. There is thus an urgent demand for membrane materials demonstrating inherently high ionic conductivity without compromising mechanical strength or environmental compatibility.

In summary, current technologies for ion-conducting membranes and separators face multifaceted challenges regarding material costs, environmental impacts, thermal and chemical stability, ionic conductivity, mechanical integrity, and ease of manufacturing. These issues collectively restrict widespread commercialization and practical applicability, particularly in economically constrained markets and environmentally conscious regions. The industry requires novel, innovative approaches employing sustainable, abundant, and biodegradable materials coupled with cost-effective, scalable, and environmentally benign manufacturing processes to overcome these limitations and achieve the desired performance metrics essential for next-generation energy storage and conversion technologies.

### BRIEF SUMMARY OF THE INVENTION

The invention is focused on the development of bio-friendly, economic, and commercially viable sepiolite clay composite membranes by using trimethyl glycine (TMG) zwitterion, known as betaine, and forming pellets using ionic liquid (1-Hexyl-3-methylimidazolium bis(trifluoromethylsulfonyl)imide) thereby abolishing the usage of polymers, metals, or carbon-based precursors.

A transition from non-renewable to renewable energy sources is needed to meet the global energy demands. Therefore, energy storage and conversion devices such as batteries, fuel cells, and supercapacitors have emerged as effective tools to adapt towards a more sustainable, reliable, and unified energy infrastructure, supporting the unification of renewable energy. However, the prevailing challenge with the existing technology is the lack of readily accessible, cost-effective, and bio-friendly sustainable advanced functional materials for the commercial feasibility of these technologies. Recently, energy storage and conversion devices have emerged with the concept of utilizing functionalized natural clays as electrode materials, solid-state electrolytes, and battery separators driven by their noteworthy features such as (1) porous structures and adsorption properties, (2) customizable surface areas, (3) impressive thermal and mechanical endurance, (4) ample natural reservoirs, and (5) cost-effectiveness. Clay-based materials have the potential to meet most of the criteria and could serve as viable options for these technologies.

The invention relates to a method for synthesizing a zwitterion-functionalized sepiolite clay composite membrane. Initially, sepiolite clay is dispersed uniformly in water to form a sepiolite clay slurry. This dispersion step can involve ultrasonic agitation, which promotes homogeneous mixing of the clay particles and ensures consistent functionalization.

The slurry is subsequently functionalized by adding at least one zwitterionic compound directly into the slurry. This zwitterionic compound attaches specifically to surface silanol sites of the sepiolite clay fibers. As a result of this attachment, the zwitterionic compound causes partial disaggregation of naturally occurring sepiolite fiber bundles, leading to structural rearrangements beneficial for the final membrane's characteristics.

The zwitterionic compounds suitable for this functionalization include betaine, also known chemically as trimethylglycine. Alternatively, zwitterionic compounds selected from the group consisting of amino acids such as alanine, arginine, proline, and valine can also be employed effectively.

Optionally, before the drying step, the slurry may further include an ionic liquid to enhance the ionic conductivity and performance characteristics of the final composite membrane. In this process, the ionic liquid becomes incorporated into the pores or channels inherently present within the sepiolite clay fibers upon drying.

Additionally, the invention encompasses the introduction of transition metal cations into the sepiolite clay slurry prior to the drying step. The metal cations suitable for doping the membrane include manganese ions (Mn²⁺), iron ions (Fe²⁺), cobalt ions (Co²⁺), and copper ions (Cu²⁺). These metal ions further modify the electrochemical and mechanical properties of the membrane.

After thorough functionalization, the zwitterion-functionalized sepiolite clay slurry is applied onto a suitable substrate. The substrate can be selected from a group consisting of metallic foils, polymer films, glass plates, or ceramic surfaces, providing mechanical support during membrane formation. Once applied, the slurry is dried under vacuum conditions at approximately ambient temperature. This drying process removes the solvent without causing thermal decomposition or damage to the zwitterionic compound, thus yielding a self-supporting composite membrane.

The zwitterion-functionalized sepiolite clay composite membrane resulting from this process is structurally characterized by sepiolite clay fibers arranged in an entangled, fibrous matrix. Zwitterionic organic molecules are securely bonded to the surfaces of these clay fibers. Critically, the composite membrane is substantially free of polymeric binders or carbonaceous fillers, and exhibits a flexible, free-standing nature suitable for practical applications.

In particular embodiments, these zwitterionic organic molecules specifically comprise betaine molecules. Alternatively, amino acids such as alanine, arginine, proline, and valine may also be utilized as the zwitterionic organic molecules bonded to the sepiolite fibers.

Further embodiments of the composite membrane include an ionic liquid retained within the pores or channels of the sepiolite clay structure. One example of a suitable ionic liquid is 1-hexyl-3-methylimidazolium bis(trifluoromethylsulfonyl)imide, known for enhancing the ionic conductivity properties of clay-based composite materials.

Moreover, the membrane may contain transition metal ions selected from manganese, iron, cobalt, or copper incorporated as dopants within the sepiolite clay structure, modifying membrane characteristics such as conductivity and mechanical resilience.

The zwitterionic functionalization described herein results in membranes characterized by an average pore diameter of at least about 10 nanometers, typically ranging between approximately 10 and 25 nanometers. This increase in pore diameter directly results from the zwitterionic modification process that disaggregates the clay fiber bundles.

The invention further extends to an electrochemical energy storage device. This device comprises at least one anode, at least one cathode, an electrolyte, and a separator positioned between the anode and cathode. The separator specifically comprises the previously described zwitterion-functionalized sepiolite clay composite membrane, allowing ionic conduction while electrically insulating the anode from the cathode.

Suitable examples of such electrochemical energy storage devices include lithium-ion batteries, sodium-ion batteries, electrical double-layer supercapacitors, and fuel cells. Certain embodiments specifically employ a betaine-functionalized sepiolite clay membrane as the separator.

Within the context of lithium-based systems, the anode can be composed of lithium metal, defining a lithium metal battery configuration. Alternatively, the anode may comprise graphite paired with a cathode made from lithium transition-metal oxide active materials, characterizing a lithium-ion battery configuration.

The electrolyte used within these devices typically includes a lithium salt, such as lithium hexafluorophosphate (LiPF₆), lithium perchlorate (LiClO₄), or lithium bis(fluorosulfonyl)imide (LiFSl), dissolved in a non-aqueous organic solvent mixture such as carbonate-based or ether-based solutions.

Additionally, the separator is designed to be water-dispersible, facilitating environmentally friendly recycling or disposal at the end of the device's life cycle. Upon exposure to water, the separator at least partially dissolves or disintegrates, simplifying recovery and recycling efforts.

Finally, the invention includes a method for manufacturing an electrochemical energy storage device using this zwitterion-functionalized sepiolite clay composite membrane. This method involves providing both an anode and a cathode, positioning the composite membrane as a separator between them, introducing the electrolyte into the assembled structure, and sealing the entire assembly within a suitable cell housing, thus creating a functional electrochemical energy storage device.

Specific embodiments of this manufacturing process include assembling lithium metal batteries by pairing a lithium metal anode with cathodes composed of lithium-intercalation compounds or sulfur-based composites. Alternatively, lithium-ion battery assemblies involve filling an assembled anode, cathode, and separator structure with a lithium-salt-containing non-aqueous electrolyte.

The method may also include a preliminary step of pre-soaking the zwitterion-functionalized sepiolite clay composite membrane with the electrolyte before placement between electrodes, ensuring thorough wetting and ionic transport efficiency. Additionally, the manufacturing process may involve winding the anode, separator, and cathode into a cylindrical configuration or stacking them in layers suitable for pouch cell configurations, enabling broad compatibility with conventional battery assembly techniques.

This invention provides the opportunity to fabricate sustainable, commercially viable, cost-effective, durable, and flexible clay membranes and pellets devoid of polymers or precursors for energy applications, such as battery separators, electrolyte membranes in fuel cells, and electrode materials in batteries and supercapacitors.

### BRIEF DESCRIPTION OF THE DRAWINGS

For a fuller understanding of the invention, reference should be made to the following detailed description, taken in connection with the accompanying drawings, in which:

FIG. 1 shows the ATR-FTIR spectra of sepiolite-zwitterion membranes with various amino acids.

FIG. 2 shows ATR-FTIR spectra of sepiolite-zwitterion membranes featuring multiple amino acids.

FIG. 3 shows TEM micrographs and SAED patterns of sepiolite-betaine membranes in Li+ environment.

FIG. 4 shows BET isotherms and pore size distributions for sepiolite-betaine composite membranes.

FIG. 5 shows XPS survey spectra and Si 2p spectra for sepiolite-betaine membranes.

FIG. 6 shows a flame stability test image captured using a thermal imager.

FIG. 7 shows the sepiolite-betaine membranes after a flame stability test at 500° C.

FIG. 8 shows a heat stability test conducted on sepiolite-betaine membranes.

FIG. 9 shows EIS spectra of sepiolite-betaine membranes in 1M LiPF₆ electrolyte.

FIG. 10 shows galvanostatic charge-discharge curves of a Li/sepiolite-betaine/Li coin cell.

FIG. 11 shows voltage profiles, capacitance retention, rate-capability, and EIS data for an NMC811/Li cell equipped with a sepiolite-betaine separator.

FIG. 12a shows the fibrous morphology and channel-based architecture of pristine sepiolite clay particles, highlighting the high surface area and accessibility of silanol groups on the surface.

FIG. 12b shows images of sepiolite-betaine composite membranes prepared at varying betaine-to-clay ratios, illustrating the physical appearance and flexibility of these membranes.

FIG. 12c shows images of sepiolite-betaine membranes in a bent state, emphasizing the changes in thickness and structural integrity related to betaine content.

FIG. 12d shows scanning electron microscopy (SEM) micrographs of pristine sepiolite clay, depicting aggregated needle-shaped fibers randomly oriented within the material.

FIG. 12e shows SEM micrographs of sepiolite clay after betaine functionalization, clearly demonstrating the disaggregation and realignment of clay fibers into an organized, porous three-dimensional “clay anemone” structure.

FIG. 12f shows X-ray diffraction (XRD) patterns of pristine and betaine-modified sepiolite clay membranes, confirming preservation of crystalline structure without significant changes in the basal d-spacing.

FIG. 12g shows X-ray diffraction (XRD) patterns for ionic liquid (IL)-modified sepiolite membranes, demonstrating that the sepiolite's crystalline structure remains intact after functionalization with ionic liquids.

FIG. 12h shows attenuated total reflectance Fourier-transform infrared (ATR-FTIR) spectra of betaine-modified sepiolite composite membranes, verifying successful functionalization by identifying distinct absorption bands characteristic of betaine groups bonded to sepiolite.

FIG. 12i shows ATR-FTIR spectra of ionic liquid-modified sepiolite composites, confirming IL incorporation through the presence of characteristic bands associated with alkyl chain vibrations of the ionic liquid.

FIG. 13a shows comparative ionic conductivity data for betaine-modified sepiolite clay membranes at various compositions and thicknesses, clearly summarizing their resistance, resistivity, and conductivity values.

FIG. 13b shows comparative ionic conductivity data for ionic liquid (IL)-modified sepiolite clay pellets, clearly presenting measurements of resistance, resistivity, and ionic conductivity for varying IL concentrations.

### DETAILED DESCRIPTION OF THE PREFERRED EMBODIMENT

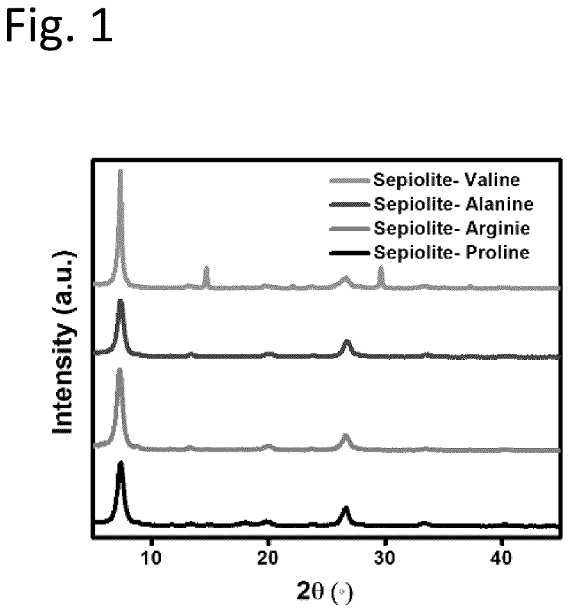

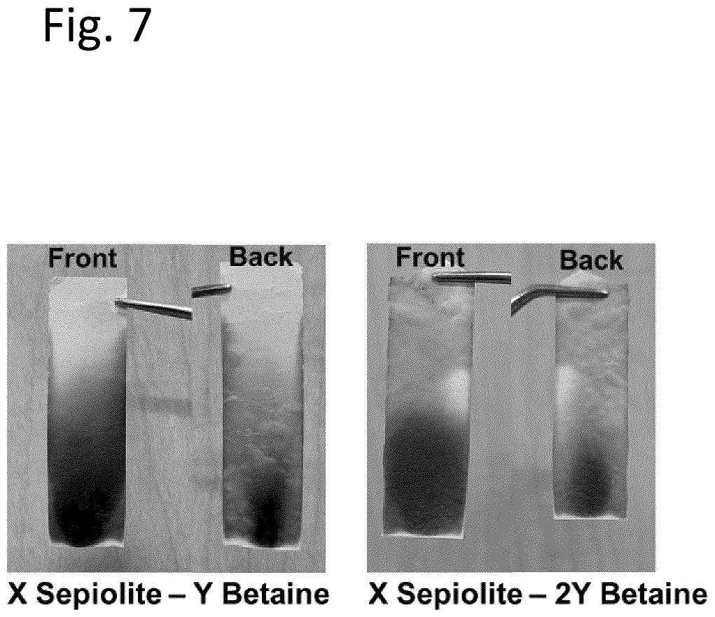

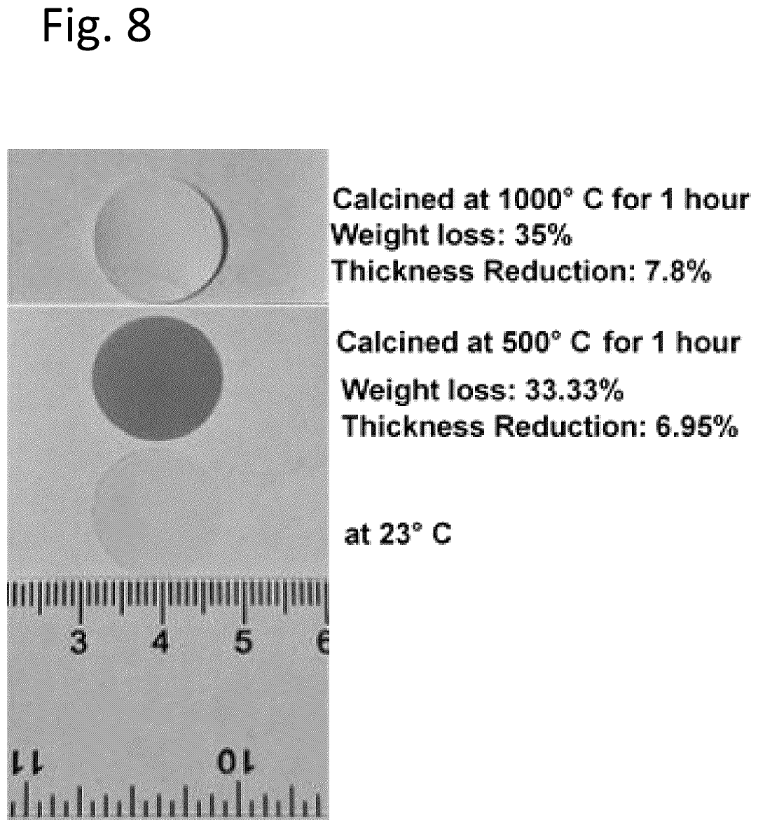

This invention concerns composite membranes formed of sepiolite clay and one or more functionalizing agents that include zwitterions, ionic liquids, or a combination of both. These composite membranes exhibit enhanced ionic conductivity, mechanical robustness, chemical stability, and a substantial degree of thermal tolerance, making them suitable for implementation in a variety of energy storage and conversion devices. FIGS. 1 through 11 illustrate data on the structural, spectroscopic, and electrochemical properties of such sepiolite-based membranes, while a placeholder for Table 1 is provided to reflect pore diameter and structural characteriszation metrics.

| Composite | Average pore diameter (nm) |
|---|---|
| Sepiolite | 3.4 |
| X Sepiolite-Y Betaine | 11.8 |
| X Sepiolite-2Y Betaine | 24.4 |
| X Sepiolite-3Y Betaine | 24.4 |

Sepiolite is a hydrated magnesium silicate mineral characterized by a fibrous morphology and a complex channel-based architecture. This architecture provides a significant cation exchange capacity and high internal surface area. Unlike many other layered clays, sepiolite contains discontinuous external silica sheets, thereby exposing a substantial number of silanol groups on its surface. These silanol groups serve as reactive sites for surface functionalization and doping. Although sepiolite is naturally abundant and features excellent heat resistance, an unmodified sepiolite membrane might not achieve the ionic conductivities necessary for high-performance energy storage or conversion. The present invention addresses this limitation by introducing zwitterion-based molecules or ionic liquids (or both) to the clay's accessible silanol sites and channel domains, thereby facilitating higher ionic transport, enhanced mechanical characteristics, and improved compatibility with battery or supercapacitor electrolytes.

Zwitterions are molecules that contain both positive and negative charges on different functional groups while maintaining overall electrical neutrality. Betaine (trimethyl glycine) is an example of such a zwitterion and has been studied extensively in the context of this invention. However, other amino acids, such as alanine, arginine, proline, and valine, may be incorporated in similar ways. Each zwitterionic species interacts with sepiolite's silanol groups, thus reconfiguring the clay's fiber bundles and partially disaggregating them. This reconfiguration increases pore accessibility and can create additional ion-conducting channels. In certain embodiments, betaine is introduced into a clay slurry formed by dispersing sepiolite in deionized water. Controlled stirring or ultrasound may be used to ensure homogeneous mixing and maximal interaction between betaine molecules and silanol sites. The slurry is then cast or coated onto an appropriate substrate, such as a thin metallic foil or a glass plate, followed by drying under vacuum to remove excess solvent and consolidate the membrane structure. Depending on the chosen betaine-to-clay ratio, the resulting membranes may differ in overall pore size, ionic transport efficiency, and mechanical flexural properties.

An alternative or parallel route employs ionic liquids, such as 1-Hexyl-3-methylimidazolium bis(trifluoromethylsulfonyl)imide. Ionic liquids are salts that remain in a liquid state at room temperature or near-room temperature, often displaying negligible vapor pressure and strong ionic conductivity. When integrated with sepiolite, these ionic liquids embed themselves within the clay's porous network, establishing continuous conductive pathways and enhancing the composite's electrochemical performance. The ionic liquid content may be varied from a few weight percent up to around ten weight percent or more, depending on the desired conductivity or mechanical behavior. As with the zwitterion route, the clay is first formed into a slurry in deionized water, and the ionic liquid is introduced prior to film casting and drying. The resulting membranes generally exhibit higher conductivities than those functionalized solely with betaine, though the presence of both betaine and an ionic liquid in a single formulation may confer distinct advantages, such as improved mechanical flexibility coupled with elevated ionic transport.

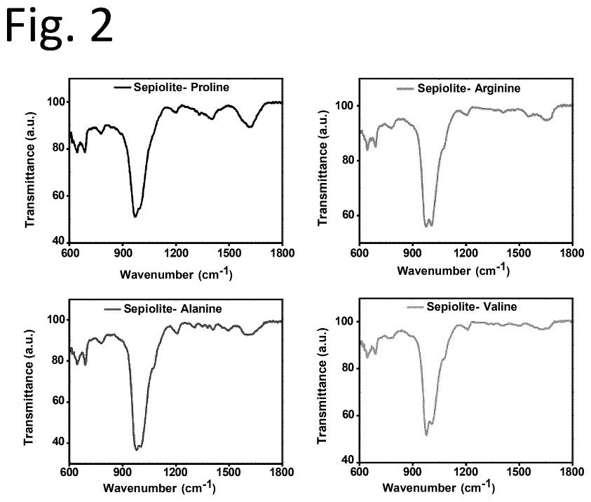

FIGS. 1 and 2 illustrate representative patterns of sepiolite-based composites subjected to X-ray diffraction and attenuated total reflectance Fourier transform infrared spectroscopy (ATR-FTIR), respectively. In unmodified sepiolite, a characteristic XRD reflection appears near 20=7.4°, consistent with known basal spacing for this clay mineral. Upon functionalization with betaine or an ionic liquid, the main reflections remain apparent, thus indicating that the clay's crystalline lattice is not significantly distorted or intercalated. Instead, the primary modifications are localized to the clay's surface or peripheral channels. ATR-FTIR spectra for betaine-modified samples typically display C—N and N—C—H absorptions in the 1300-1400 cm⁻¹ region, along with possible C═O stretching bands near 1600-1700 cm⁻¹, suggesting that betaine's zwitterionic groups have successfully bonded or adsorbed onto sepiolite surfaces. ATR-FTIR data for ionic liquid-based composites may exhibit additional bands linked to alkyl chain stretching or imidazolium ring vibrations, signifying the presence of ionic liquid moieties within the membrane.

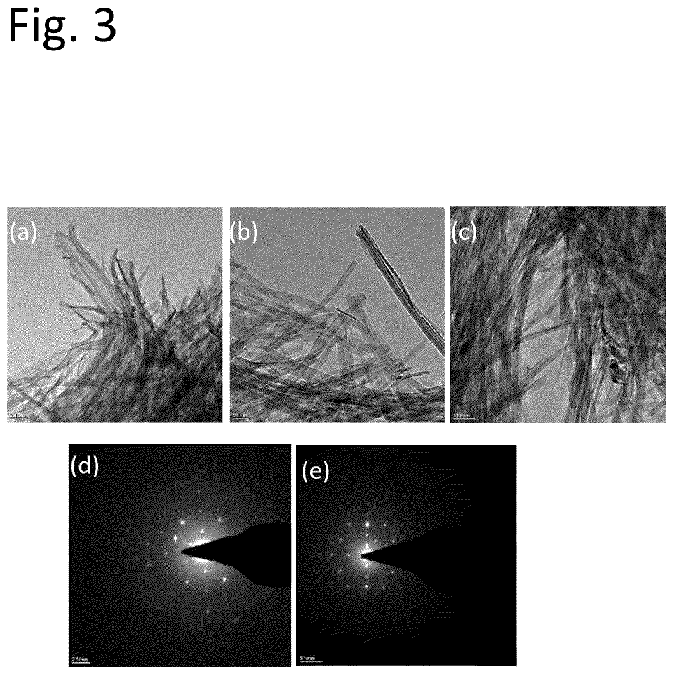

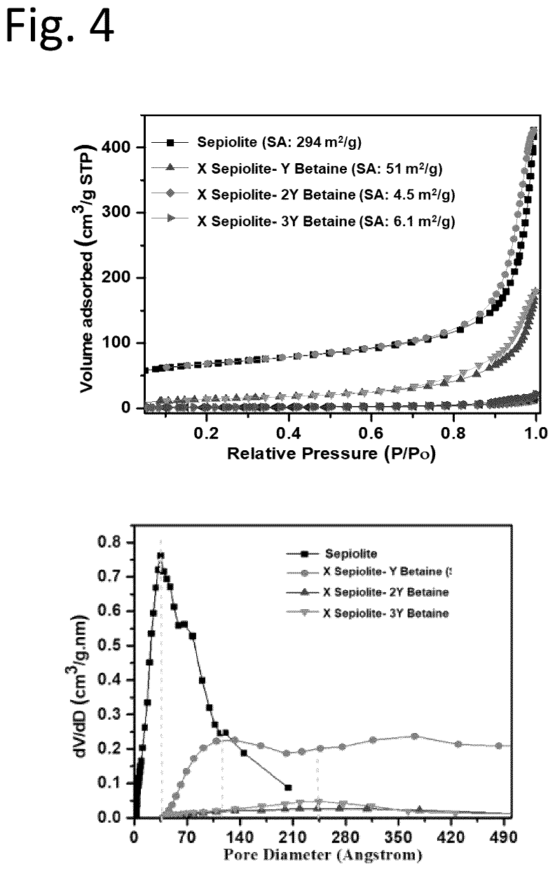

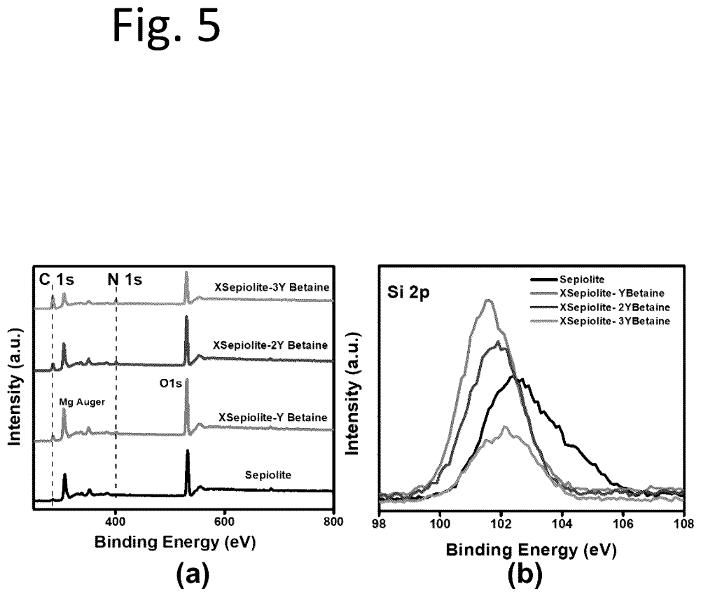

FIG. 3 provides transmission electron microscopy (TEM) and selected area electron diffraction (SAED) data demonstrating morphological transitions from aggregated needlelike bundles in the pristine clay to more open, “anemone-like” bundles after functionalization. These morphological rearrangements enhance ionic diffusion by eliminating excessive fiber entanglement, resulting in greater pore accessibility and conduction pathways. In certain embodiments, doping with minor amounts of transition metal ions (for instance manganese, iron, cobalt, or copper) may also be introduced, either in conjunction with betaine or ionic liquids, to achieve further specialization of mechanical or electrochemical properties. FIG. 4 includes Brunauer-Emmett-Teller (BET) surface area measurements and pore-size analyses. Although partial coverage of micropores by zwitterionic or ionic liquid species may reduce the overall accessible surface area, the net effect can be advantageous if it promotes continuous ion-transport corridors. FIG. 5 highlights X-ray photoelectron spectroscopy (XPS) data, revealing more pronounced C 1s and N 1s peaks upon betaine or ionic liquid addition, along with shifts in Si 2p and O 1s binding energies that imply strong surface interactions.

Table 1 describes measured pore diameters in nanometers for pristine sepiolite and for variants functionalized with different betaine loadings. These data show that unmodified sepiolite typically has an average pore diameter of around 3-4 nm, while partial or full functionalization with betaine can raise pore diameters into the 10⁻²⁵ nm range, likely as a result of disaggregating fiber bundles and introducing additional channels or voids.

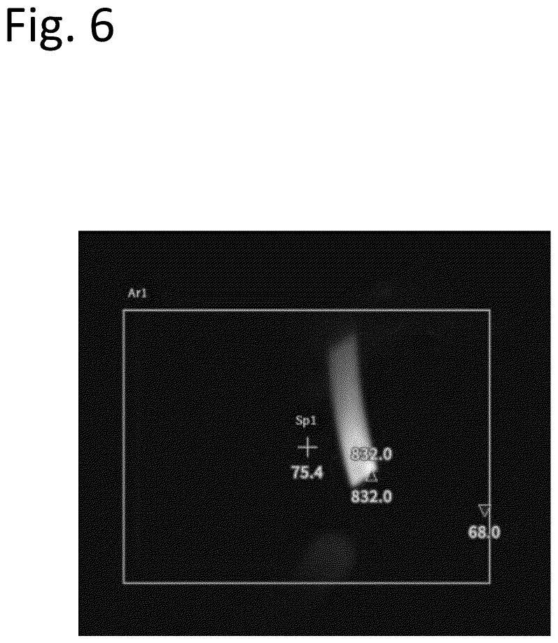

FIGS. 6, 7, and 8 relate to the thermal and flame stability of these membranes. Flame tests capture static images or thermal imager readings of membranes exposed to direct flame at around 500° C. The data confirm that these sepiolite-based composites resist combustion significantly better than conventional polymer separators, which often degrade or melt below 200° C. The inorganic clay matrix can release structural water at elevated temperatures, moderating local heat buildup, and in some cases forming a partial char layer that further impedes oxidation. Mechanical distortion remains minimal, as indicated by the minimal curling or radial shrinkage observed up to 500° C. These properties elevate the safety profile of the disclosed membranes in battery or supercapacitor applications where thermal runaway or external heat sources represent major failure modes.

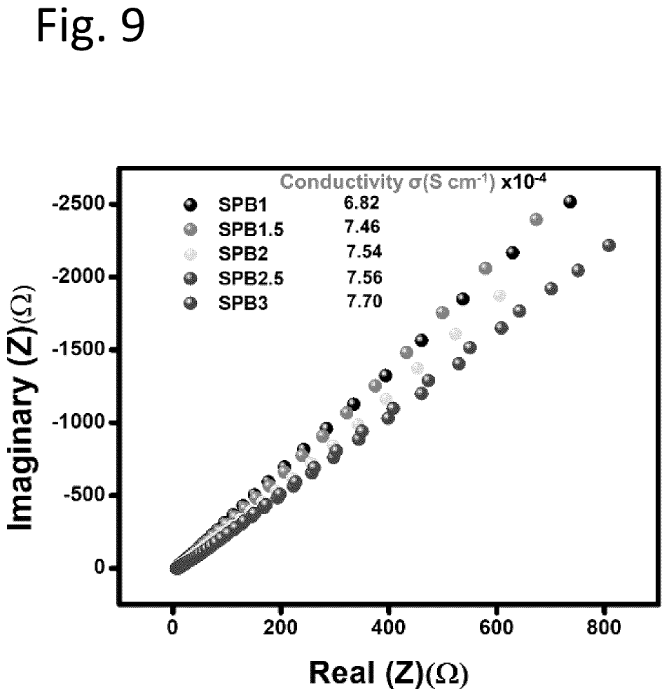

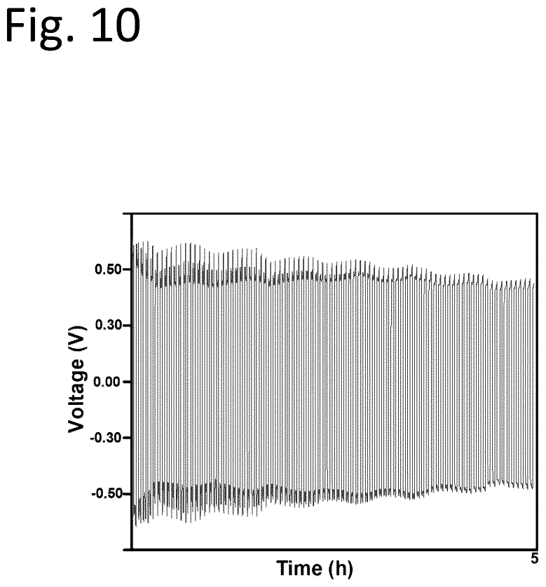

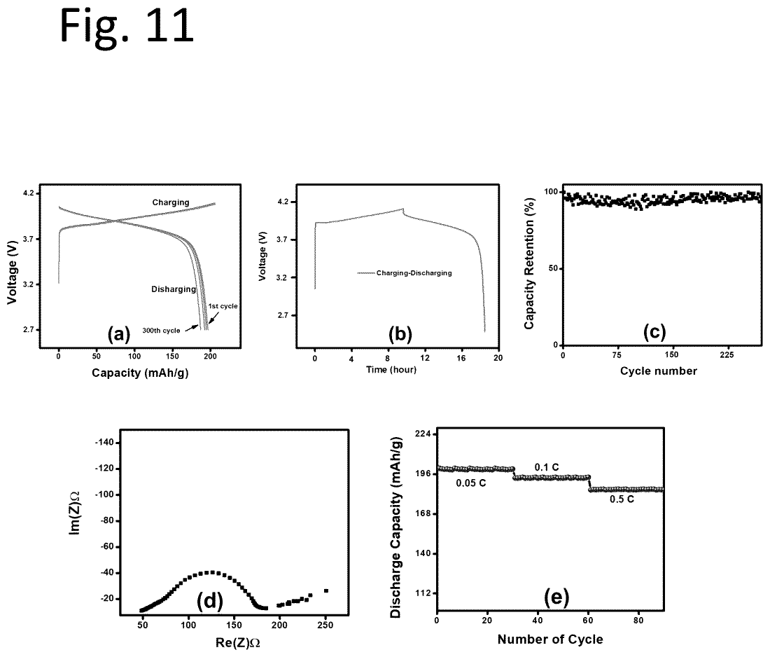

FIGS. 9, 10, and 11 present electrochemical impedance spectroscopy (EIS), galvanostatic charge-discharge (GCD), and extended cycling performance, respectively. In EIS measurements, the Nyquist plots for betaine-modified sepiolite membranes frequently show charge-transfer arcs that correspond to ionic conductivities in the range of 10⁻⁵ to 10⁻⁴ S cm⁻¹, depending on the concentration of dopant and the nature of the electrolyte soak. The incorporation of ionic liquids can elevate conductivities toward 10⁻² S cm⁻¹, approaching values commensurate with advanced polymer-ceramic or gel electrolyte systems. GCD curves in FIG. 10 from Li/sepiolite-betaine/Li coin cells exhibit stable voltage plateaus during repeated charge-discharge cycles, with negligible polarization losses, indicating the composite membrane does not introduce significant internal resistance. In the extended cycling data of FIG. 11, employing an NMC811 cathode and a lithium metal anode, the betaine-functionalized sepiolite membrane preserves around ninety-eight percent of its initial capacity after three hundred cycles at a 0.05 C rate, supporting the notion that the membrane remains structurally intact, chemically stable, and capable of sustaining repeated ion transport events. Minimal morphological degradation is verified through postmortem electron microscopy and XPS evaluations that show only slight shifts in elemental composition or binding energies after extensive cycling.

Although lithium-ion devices receive a primary emphasis, sodium-ion batteries can also benefit from these membranes. Sodium's greater ionic radius often necessitates modifying the clay structure or adjusting the additive ratio to sustain adequate pore size and conduction channels. In supercapacitors, where short, high-current pulses define device operation, the clay-based membranes display fast ion mobility and stable double-layer formation, owing to the presence of ionic liquid or zwitterionic species that reduce ohmic losses. Some embodiments may further adapt the membranes for fuel cell applications if the clay and doping agents remain stable in mildly acidic or basic media, though the invention focuses chiefly on non-aqueous electrolytes and rechargeable battery contexts.

The beneficial environmental profile of sepiolite-based membranes is linked to the clay's availability and biodegradability. Many polymer membranes used in batteries are derived from petroleum-based feedstocks, persist in landfills, or require complex recycling. By contrast, if these sepiolite composites reach an end-of-life stage, they may disintegrate in water or degrade under microbial processes, leaving relatively benign mineral residues. The minimal reliance on harsh chemical solvents during manufacturing, as the majority of steps involve water-based dispersions and vacuum drying, further supports a reduced carbon footprint. Production typically entails dispersing raw sepiolite in deionized water, then introducing betaine or ionic liquid at the desired ratio, followed by thorough mixing, casting, and drying. This approach avoids halogenated solvents, strong acids, or other reagents that pose disposal or safety issues.

The synergy between clay scaffolding and organic or ionic dopants is key to achieving the combined advantages of thermal stability, mechanical resilience, and enhanced ionic transport. Some doping strategies involve exchanging cations within the clay's channels or surface sites with transition-metal ions that may modulate redox behavior or mechanical stiffness. Spectroscopic data, including XPS, confirm that these doping species generally localize on the clay's accessible surfaces, and XRD reveals minimal shift in main diffraction peaks, indicating the fundamental silicate structure remains. In addition to betaine or ionic liquid doping, polymeric or carbon-based additives may optionally be introduced in trace amounts, although this invention generally emphasizes polymer-free, metal-free, or carbon precursor-free routes to maintain cost advantages and environmental benefits.

The mechanical properties of the membranes are important in large-scale manufacturing and device assembly. While sepiolite can be somewhat brittle, functionalization with zwitterions, ionic liquids, or small amounts of plasticizing additives tends to impart greater flexibility. This can reduce defects during cell assembly or repeated handling. Membrane thickness may be set from a few micrometers up to several hundred micrometers, depending on the slurry's solids content, the casting technique, and the drying protocol. Adjusting thickness is a tradeoff between internal ionic resistance (thinner membranes are advantageous for low ohmic drop) and mechanical durability (thicker membranes better withstand tear or puncture). Post-processing methods such as calendering or mild pressing can further refine thickness uniformity.

In single-use or short-lifespan devices, the membrane's biodegradability helps reduce waste and environmental impact. Even in more durable battery or supercapacitor systems, the potential for simpler end-of-life disposal can address mounting concerns over the recycling of consumer electronics. Moreover, the natural abundance of sepiolite, combined with the moderate cost of betaine or ionic liquid dopants, can render the overall process cheaper than specialized polymer-ceramic hybrids that often rely on costly raw materials or complex multi-stage syntheses. Although the ionic conductivity of these clay-based membranes is slightly lower than that of purely liquid electrolytes, it is sufficient for stable cycling in a range of energy storage contexts, particularly if the doping level is optimized.

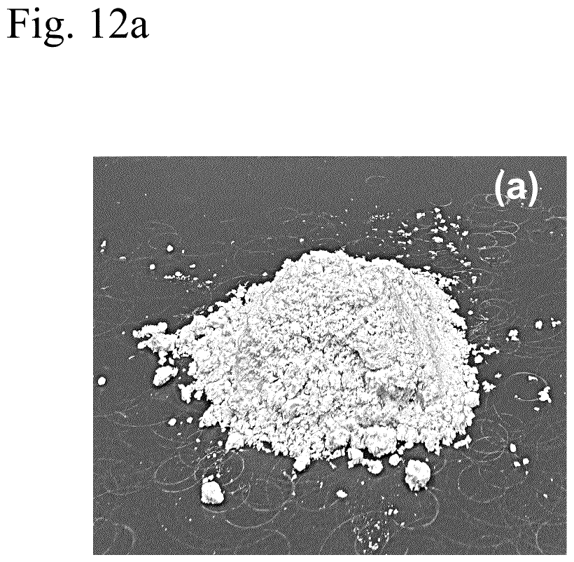

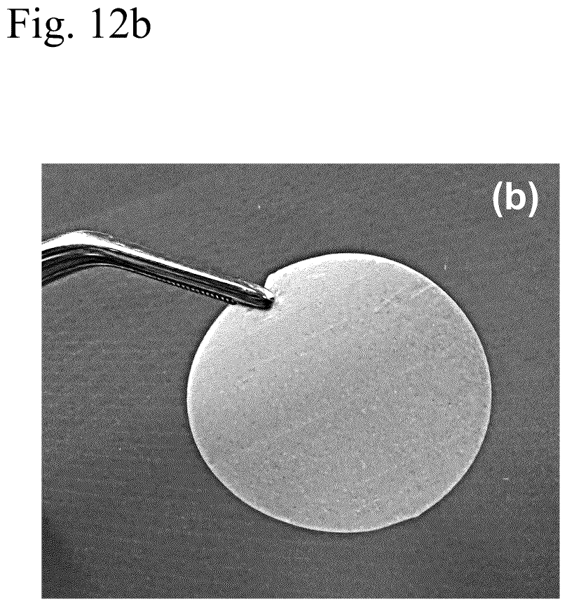

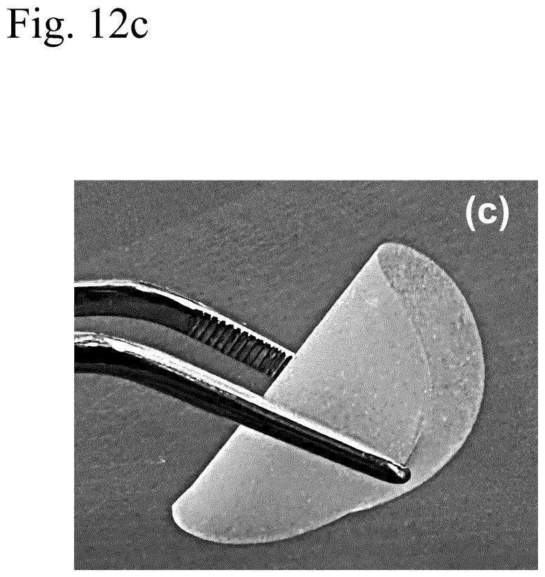

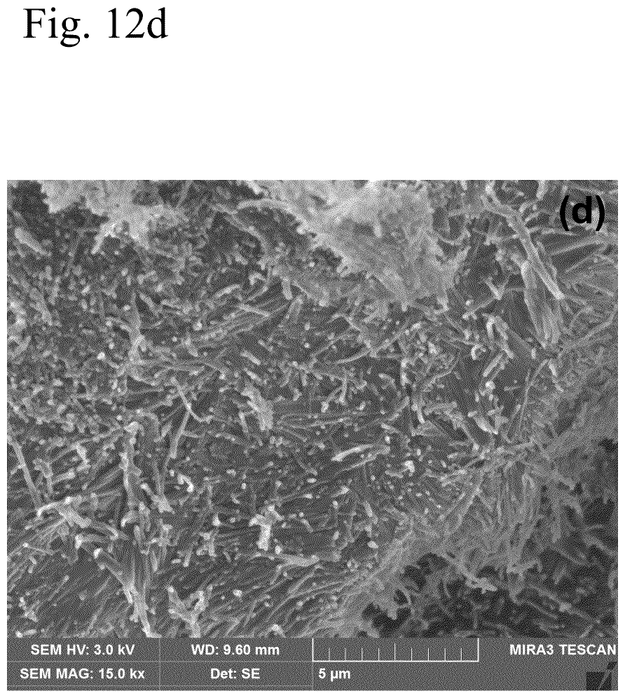

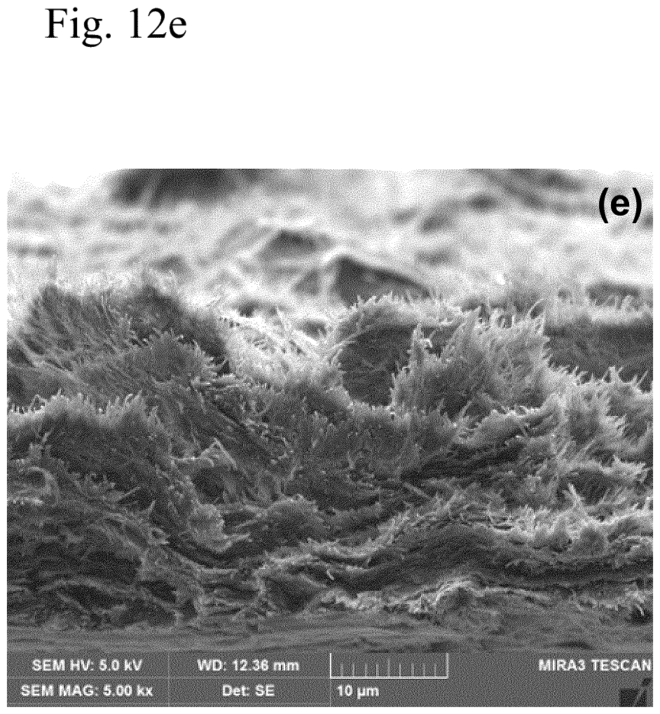

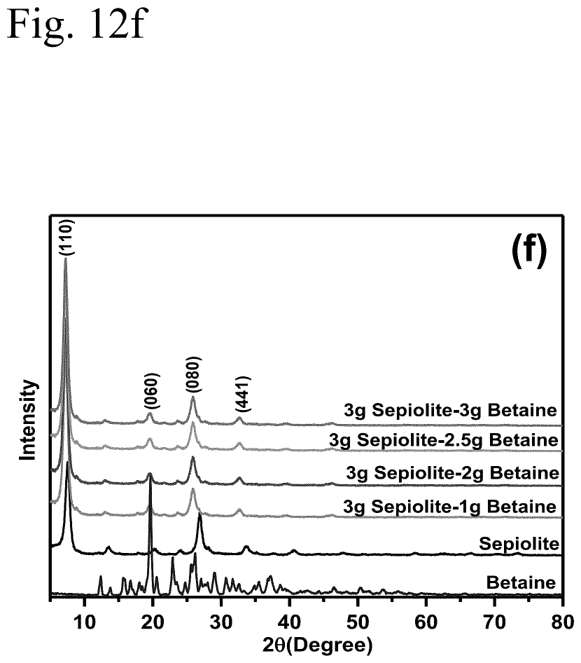

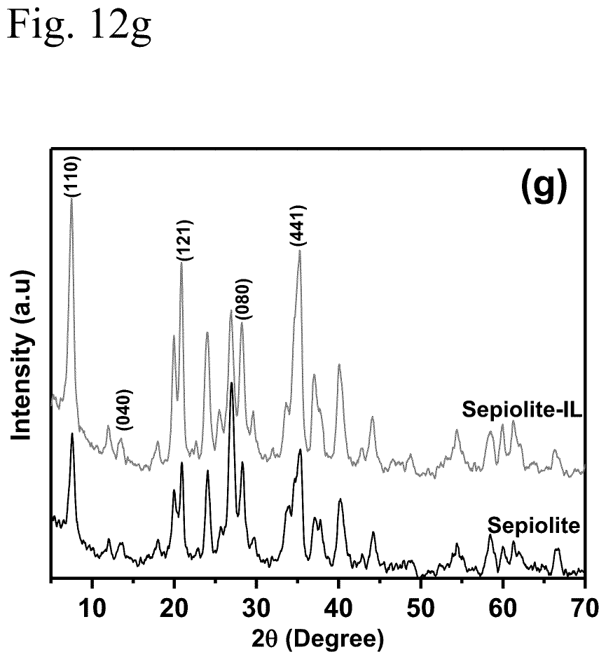

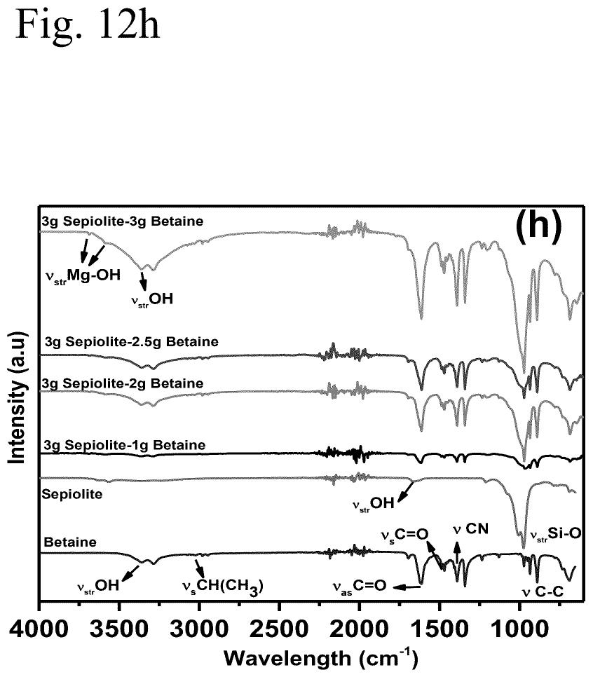

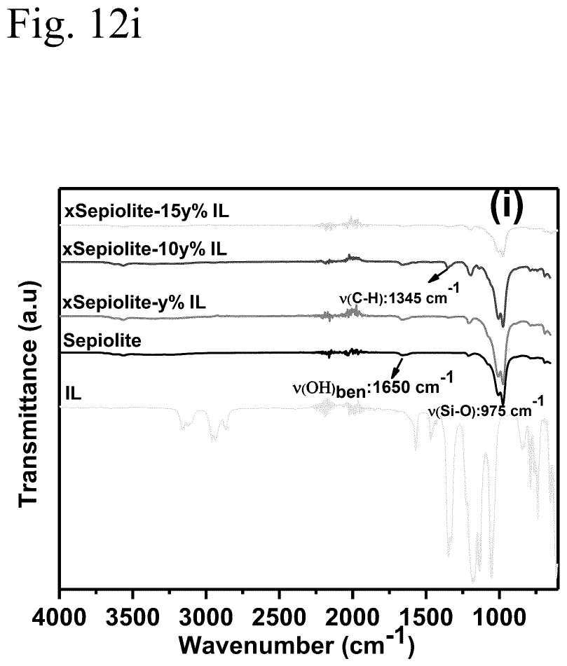

Naturally occurring clays exhibit tunable chemical traits owing to the inherent layered silicate structures and the presence of interchangeable, intercalated ions. Sepiolite (FIG. 12a), a hydrated magnesium silicate, has a fibrous clay structure with a high surface area and aspect ratio. Disruptions in the external silica sheet through blocks and channels in sepiolite offer significant exposure of surface-silanol groups that are readily accessible for functionalization with organic and inorganic moieties. Moreover, its exceptionally high surface area and appreciable cation exchange capacity (CEC) compared to other clays facilitate facile functionalization, imparting excellent mechanical durability and material properties for myriads of applications.

Betaine-functionalized sepiolite clay composites have been synthesized to fabricate flexible and mechanically robust membranes. The amount of betaine varies to create composites with varying compositions and investigate the impact of betaine content in membrane formation (FIGS. 12b and 12c). These membranes are characterized using powder X-ray diffraction, ATR-FTIR, XPS, surface area analyses, and imaging techniques (e.g., SEM). Morphological analyses reveal the highly aggregated needle-shaped sepiolite fibers, which are randomly aligned (FIG. 12d). Upon addition of betaine, such bundles disaggregate and align uniformly, forming a 3D network with unique “clay anemone” structures (FIG. 12e). The XRD patterns are consistent with the literature, confirming the absence of any change in the d-spacing and corresponding 2θ value before and after betaine modification (FIG. 12f). ATR-FTIR spectra of the sepiolite-betaine composite membranes exhibit the stretching frequencies corresponding to Sepiolite and Betaine, suggesting the functionalization of sepiolite clay by betaine (FIG. 12h).

Further, the electrochemical impedance spectroscopy (EIS) technique is employed to measure the ionic conductivity of betaine-modified sepiolite membranes using lithium perchlorate (LiClO4) in ethylene carbonate (EC) and dimethyl carbonate (DMC) mixed solvent (1:1). The ion transfer dynamics through the membranes is monitored by recording the changes in ionic conductivity while varying the concentration of LiClO4.

Further, the sepiolite clay is modified by [HMIM] BF4 ionic liquid (IL) to study the effect of functionalization by various species on clay. A facile synthesis of the IL-modified sepiolite composites is achieved by varying the concentration of IL to enhance the ionic conductivity of sepiolite clay. The absence of any change in the 20 values and peak intensities in the powder XRD spectra of sepiolite-IL composites confirmed that the crystalline structure of the pristine sepiolite clay is preserved even after functionalization with IL (FIG. 12g). The ATR-FTIR confirms the IL-sepiolite modification on the appearance of a new band attributed to—CH stretching frequency from the alkyl chains of IL in the clay structures (FIG. 12i). The IL-sepiolite composite is pressed into pellets and subjected to conductivity measurements. IL-modified sepiolite composites exhibit superior ionic conductivity compared to betaine-sepiolite composites, providing a distinct enhancement in the electrochemical properties.

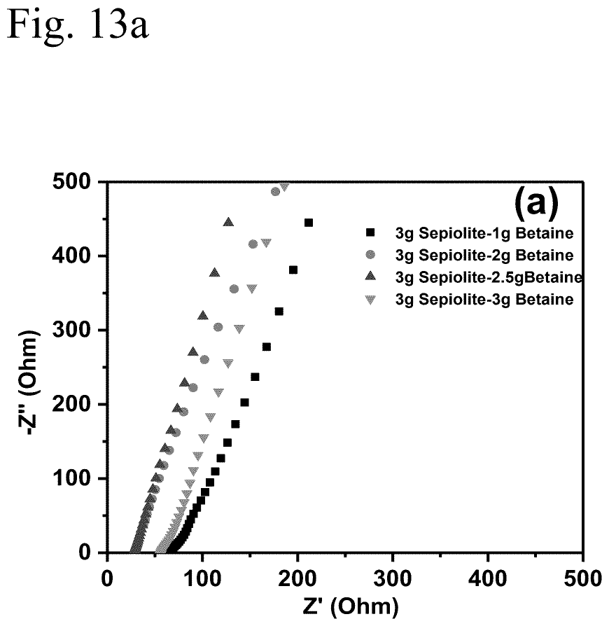

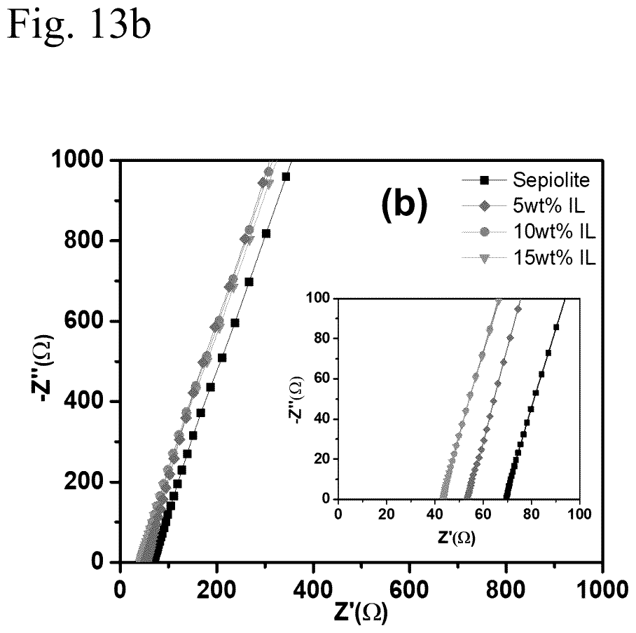

A comparison of ion-conductivity of Betaine-modified Sepiolite clay membranes is provided in Table 2 which corresponds with FIG. 13a.

TABLE 2

| | Resistance | Resistivity | Conductivity |
|---|---|---|---|
| Composition | (Ω) | ρ(Ω · cm) | σ (S cm⁻¹) |
| 3 g Sep:1 g Betaine | 62 | 48670 | 2 × 10⁻⁵ |
| (0.04 mm) | | | |
| 3 g Sep:2 g Betaine | 38 | 19886 | 5 × 10⁻⁵ |
| (0.06 mm) | | | |
| 3 g Sep:2.5 g Betaine | 27 | 14130 | 7 × 10⁻⁵ |
| (0.06 mm) | | | |
| 3 g Sep:3 g Betaine | 55 | 24671 | 4 × 10⁻⁵ |
| (0.07 mm) | | | |

A comparison of ion-conductivity of IL-modified sepiolite clay pellets is provided in Table 3 which corresponds with FIG. 13b.

TABLE 3

| | Resistance | Resistivity | Conductivity |
|---|---|---|---|
| Composition | (Ω) | ρ(Ω · m) | σ (Ω⁻¹ · m⁻¹) |
| 95 Sepiolite-5 | 52.08 | 77.64 | 1.2 × 10⁻² |
| Wt % IL | | | |
| 90 Sepiolite-10 | 43.55 | 64.92 | 1.5 × 10⁻² |
| Wt % IL | | | |
| 85 Sepiolite-15 | 43.51 | 64.84 | 1.5 × 10⁻² |
| Wt % IL | | | |

| | |
|---|---|
| Thickness of pellet = 2.58 mm | Diameter of pellet = 7.15 mm |

In certain embodiments, the user may combine betaine and an ionic liquid to form a hybrid doping system. Betaine can promote partial fiber disaggregation, introduce positively and negatively charged sites, and thereby amplify ionic conduction channels, while an ionic liquid further lowers internal resistance and broadens the operating temperature range for conduction. The synergy of these dopants can surpass what either species alone might achieve, furnishing membranes that retain mechanical coherence yet deliver ionic conductivities on the order of 10⁻² S cm⁻¹ under optimized conditions. A specialized doping ratio, possibly five to ten weight percent betaine and up to ten weight percent ionic liquid, can be selected to match a target device's power requirements and thermal envelope.

Alternative doping or functionalization steps may also be applied, such as exchanging sepiolite's inherent magnesium ions with other cations to adjust the clay's interchannel interactions. Small amounts of polymeric binders may optionally be used, although the invention principally seeks to avoid such binders for simplicity and environmental reasons. The ease of re-dispersion in water or mild solvents can lead to straightforward recycling or reprocessing, consistent with the broader objectives of sustainable engineering. Because the invention focuses on the use of water as the primary dispersant, minimal equipment beyond vacuum ovens, mixing vessels, and substrate-handling tools is required to produce membranes at a laboratory or pilot scale. Scale-up can be realized by adapting the casting and drying steps to roll-to-roll processes or continuous coating lines, wherein the clay slurry is deposited at a controlled rate onto a flexible metal or polymer substrate, dried under reduced pressure, and then cut or layered for battery assembly.

Comparisons to prior art reveal that conventional polymer separators, such as those made from polypropylene or polyethylene, may exhibit weaker thermal stability and require additional treatments (for instance ceramic coating) to achieve comparable heat resistance. Ceramic-polymer hybrids often involve specialized sintering or infiltration procedures, incurring higher costs and environmental burdens. By centering the invention on naturally abundant sepiolite and relatively accessible functional additives, a more cost-effective route emerges, especially relevant in markets that demand large-scale production of batteries, supercapacitors, or other electrochemical devices. The emphasis on biodegradable or water-dispersible behavior further widens the scope to applications in disposable or single-use power systems, which benefit from minimal post-use pollution.

Although the invention has been primarily demonstrated with lithium-based cells, the principles extend to other alkali metal systems, such as sodium, potassium, or magnesium, provided the pore architecture and doping strategies are adapted to each ion's size and reactivity. Fuel cell membranes typically require proton conduction in acidic media, implying possible modifications to preserve the clay-zwitterion interface under acidic conditions. Additional cross-linking or doping with proton-conductive groups can yield membranes that endure in hydrogen fuel cells, though that aspect is not the main focus here. The mechanical properties, doping tolerance, and viability across different temperature or solvent conditions indicate that the disclosed clay-based composites can be extended or tweaked for a broad range of advanced energy applications.

### Glossary of Claim Terms

Ambient temperature means the temperature of the surrounding environment, typically around 20° C. to 25° C. (68° F. to 77° F.), under normal atmospheric conditions and without additional heating or cooling. In the context of the described invention, performing a process at ambient temperature indicates that steps such as drying a sepiolite clay slurry into a membrane are conducted at approximately room conditions rather than at elevated temperatures. Drying under ambient temperature (especially when combined with vacuum conditions) ensures that sensitive components like the zwitterionic additives (e.g., betaine or ionic liquids) do not undergo thermal decomposition or other degradation, preserving their functionality within the composite membrane. By avoiding the need for high-temperature curing, the method demonstrates an energy-efficient and gentle approach to membrane fabrication. Ambient temperature processing also helps maintain the structural integrity of both the clay fibers and the attached organic functional groups, as no thermal stress or significant shrinkage is introduced during drying. This approach simplifies manufacturing requirements by eliminating specialized heating equipment and reducing energy consumption. While “ambient” can fluctuate depending on local climate or lab conditions, in practice it refers to a range of normal indoor temperatures at which the process has been validated to work effectively. The patent emphasizes that drying the slurry at ambient temperature distinguishes this invention from processes that require additional heat input, highlighting the ease and safety with which the composite membrane can be formed under standard conditions.

Anode means the electrode in an electrochemical cell where oxidation occurs during the discharge cycle, leading to the release of electrons into an external circuit. In modern battery systems, including lithium-ion and sodium-ion batteries, the anode is often composed of materials such as graphite, lithium titanium oxide, or lithium metal, each chosen for its distinct electrochemical potential and stability profile. The performance of the anode has a direct bearing on the energy density, rate capability, and overall lifecycle of the battery. This is because the reversibility of the redox reactions at the anode determines how many times the battery can be charged and discharged without significant capacity fade. Anodes also play a crucial role in mitigating safety concerns by influencing phenomena such as lithium plating or dendrite formation, which can cause internal short circuits under extreme conditions. Material scientists are continually investigating novel anode materials, such as silicon and tin-based composites, to push the boundaries of theoretical capacity and improve cycle life. Additionally, research efforts extend to optimizing electrode microstructure through advanced fabrication techniques, aiming for uniform particle size distributions and high porosity to promote fast ionic and electronic transport. Consequently, the anode's design, composition, and structural integrity remain pivotal in shaping the performance and safety profile of a wide range of electrochemical energy storage devices.

Betaine means a specific zwitterionic compound (chemically known as trimethylglycine) that contains both a positively charged quaternary ammonium group and a negatively charged carboxylate group in the same molecule, resulting in an overall neutral charge. In the context of this invention, betaine serves as a functionalizing agent for sepiolite clay. When introduced into the sepiolite clay slurry, betaine molecules attach to the clay's surface silanol sites (Si—OH groups) through electrostatic and hydrogen-bond interactions. This attachment introduces both positive and negative sites onto the clay's surface, enhancing the clay's dispersibility in water and partly disassembling the clay's natural fiber bundles. By partially disaggregating these fibrous bundles, betaine creates a more open, porous network within the clay structure-often described as adopting an “anemone-like” morphology-thereby increasing the accessible surface area and ionic pathways of the resulting membrane. The presence of betaine in the dried composite membrane contributes to improved ionic conductivity, as the zwitterionic groups can facilitate ion transport and retain electrolyte species within the clay's channels. Additionally, betaine is a naturally derived, biodegradable substance (commonly found in sugar beets and other organisms), aligning with the invention's emphasis on environmentally benign materials. Its inclusion in the membrane composition helps achieve a high-performance separator that avoids traditional polymer binders, leveraging betaine's dual-charge characteristics to stabilize the clay matrix and enhance electrochemical functionality without compromising the membrane's flexibility or thermal stability.

Biodegradable means the characteristic of a substance that enables it to be broken down naturally by microorganisms, enzymes, or other biological processes into simpler compounds that can be assimilated into ecosystems without causing long-term harm. In the realm of materials science, biodegradability plays an increasingly important role as industries seek sustainable alternatives to conventional polymers and composites. A biodegradable membrane or component can reduce the environmental impact associated with waste disposal at the end of a product's life cycle, mitigating the accumulation of non-degradable materials in landfills and aquatic systems. The biodegradation process involves complex interactions between the material's chemical bonds and biological agents, typically resulting in byproducts like carbon dioxide, water, or inorganic salts, which can be reintegrated into natural nutrient cycles. In energy storage devices such as batteries and supercapacitors, biodegradable materials can be particularly beneficial for single-use or short-lifespan applications, where safe and efficient disposal is paramount. Moreover, employing biodegradable materials does not necessarily compromise performance if the composite structure is designed with robust mechanical properties and stable electrochemical behavior within the device's operational window. Researchers investigating biodegradable materials often look for synergies between renewable resources-like certain clays, cellulose derivatives, or chitosan—and functional additives to achieve a balance of mechanical strength, ionic conductivity, and environmentally friendly disposal. As environmental regulations tighten worldwide, the demand for biodegradable components is likely to rise, making the development of such materials a focal point in sustainable engineering and product design.

Cathode means the electrode in an electrochemical cell at which reduction reactions occur during discharge, thereby absorbing electrons from the external circuit. The role of the cathode is central to determining key performance metrics such as voltage, capacity, and energy density in battery systems. Common cathode materials in lithium-ion batteries include lithium cobalt oxide, lithium manganese oxide, and layered oxides with nickel, manganese, and cobalt, each exhibiting specific operational voltages and capacities. By contrast, sodium-ion batteries might employ transition metal-based compounds like sodium cobalt oxide or layered oxides tailored for sodium intercalation. The cathode's ability to reversibly insert and extract cations (e.g., Li+ or Na+) under applied potentials directly impacts both the battery's overall efficiency and its cycle life. Its crystal structure, elemental composition, and morphology govern parameters like ionic diffusion pathways, electron transport, and susceptibility to degradation. Temperature stability is another vital consideration, as cathodes can undergo phase transformations or side reactions when exposed to high temperatures, contributing to capacity fade and potential safety risks. Researchers often look to surface coatings, doping strategies, and advanced synthesis routes to enhance cathode stability, rate capability, and electrochemical robustness. In addition, environmental and cost factors play a growing role in cathode development, propelling investigations into cobalt-free or manganese-rich compositions. As the cathode typically determines a major fraction of the cost in lithium-ion and sodium-ion batteries, innovations that improve performance while reducing reliance on scarce or toxic elements have broad implications for commercial viability, sustainability, and large-scale manufacturing.

Ceramic Substrates means inorganic, non-metallic support materials, often composed of compounds like alumina (Al₂O₃), zirconia (ZrO₂), or silica (SiO₂), recognized for their high hardness, chemical inertness, and remarkable thermal stability. These substrates are frequently utilized in advanced energy storage and conversion applications, including fuel cells, batteries, and specialized composite membrane systems. Due to their dimensional stability at elevated temperatures, ceramic substrates can maintain structural integrity where polymeric or metallic counterparts might deform or degrade. The inherent chemical resistance of ceramics also proves advantageous in corrosive or oxidative environments, which may be encountered during battery cycling or in chemical processing setups. Additionally, the surface characteristics of ceramic substrates-including porosity, roughness, and surface energy—can be engineered or modified to improve adhesion and compatibility with coatings, thin films, or functional layers, such as clay-based membranes or catalyst deposits. Sintering and tape-casting are typical manufacturing methods used to produce ceramic substrates with controlled microstructures, thicknesses, and mechanical properties. Despite their benefits, ceramics can exhibit brittleness, necessitating careful handling and, in some cases, the incorporation of reinforcing phases or composite strategies. In this invention, a ceramic substrate (for instance, a sintered alumina plate) can serve as the base on which the clay slurry is cast and dried, taking advantage of the substrate's high thermal stability and smooth surface to form a defect-free membrane. The synergy between ceramic substrates and emerging functional materials may open new avenues for robust, high-performance energy devices, effectively balancing mechanical resilience, chemical stability, and thermal endurance.

Clay Slurry means a semi-liquid suspension of finely dispersed clay particles, such as sepiolite, blended with a solvent, most commonly deionized water. This mixture forms the foundational step in processes that transform raw clay into functional composite materials or membranes. Achieving a uniform distribution of clay particles is vital for controlling the final properties of the cured membrane, including thickness homogeneity, mechanical flexibility, and ionic conductivity. The degree of dispersion can be influenced by variables like the pH of the medium, the concentration of clay, and the presence of dispersants or surfactants. In energy storage applications, additives such as zwitterions, ionic liquids, or dopants may be introduced into the slurry to tailor specific functionalities, for instance to enhance the membrane's conductive pathways or mechanical robustness. Processing techniques-like stirring, sonication, or milling-aid in breaking up agglomerates and ensuring even particle dispersion throughout the fluid matrix. Once the slurry is applied onto a substrate via casting, printing, or coating methods, it undergoes drying or sintering stages that lock the clay particles in place, forming a coherent membrane or film. Control over the slurry's rheological properties (e.g., viscosity and flow behavior) is paramount, as it impacts both the membrane's microstructural development and the reproducibility of the synthesis process. Optimized slurry preparation underpins the quality, scalability, and performance of clay-based membranes in various devices.

Composite Membranes mean engineered structures formed by combining two or more distinct materials, such as clays, polymers, metals, or carbon nanostructures, into a unified architecture where each component imparts complementary properties. The objective is to create a membrane with superior chemical, mechanical, or electrochemical characteristics that surpass those of the individual constituents. In the context of energy storage devices-like batteries, supercapacitors, and fuel cells—an effective composite membrane must facilitate ionic transport while maintaining robust mechanical stability, chemical inertness, and consistent thickness. For example, a sepiolite clay-based composite might integrate zwitterions or ionic liquids to improve ionic conductivity and flexibility, addressing challenges such as capacity fade and heat generation over long cycling periods. Synthesis methods for such membranes often involve dispersing the chosen materials in a suitable medium, followed by processes like casting, coating, or pressing onto substrates. The interplay between fillers (such as clay particles or fibers) and matrices (which might be polymeric or ceramic) determines fundamental properties including porosity, conductivity, and mechanical resilience. Technological advances in nanofabrication and functionalization techniques further expand the design space, enabling the tuning of interfacial interactions, pore architecture, and morphological features at micro—and nanoscale levels. Composite membranes represent a strategic approach to resolving multifaceted constraints in advanced energy systems, combining the strengths of multiple materials into a single, high-performance solution.

Deionized Water means water that has been purified through ion exchange or other filtration processes to remove nearly all dissolved ions, including cations (e.g., sodium, calcium) and anions (e.g., chloride, sulfate). This highly purified state eliminates potential contaminants that can adversely affect chemical reactions, stability, or conductivity in sensitive applications, particularly in membrane synthesis and electrode fabrication. By using deionized water in forming clay slurries or rinsing materials, researchers ensure the reliability and reproducibility of experimental protocols. Any ionic impurities present in regular water can disrupt the electrostatic environment, catalyze unwanted side reactions, or interfere with the functionalization process. For instance, in the context of sepiolite clay modification, the absence of extraneous ions is crucial for maintaining controlled interactions between the clay's active sites and additives such as zwitterions or ionic liquids. Deionized water also helps preserve the intended pH and conductivity of the system, ensuring that the physical and chemical characteristics of the resulting membranes remain consistent with design specifications. In industrial-scale production, water purification systems are indispensable for achieving uniform product quality and minimizing process variability. Consequently, deionized water stands as a key ingredient in advanced manufacturing workflows where precision, cleanliness, and chemical integrity are paramount. In this invention, the exclusive use of deionized water for preparing the clay slurry ensures that no unintended ions interfere with the bonding of zwitterions to the clay or the development of the membrane's microstructure, thereby contributing to the reproducibility and performance of the final composite membrane.

Disaggregation means the process of breaking up or separating aggregated particles or fibers into smaller units or individual components, thereby achieving a more uniform dispersion. In the context of sepiolite clay membranes, disaggregation refers specifically to the breaking apart of the clay's naturally entangled fiber bundles. Sepiolite is a fibrous clay mineral whose needle-like particles tend to cluster together via van der Waals forces and hydrogen bonding, forming bundles that can impede uniform mixing and pore accessibility. By disaggregating these bundles-through methods such as ultrasonic agitation, vigorous stirring, or chemical functionalization (e.g., with a zwitterion like betaine)—the individual clay fibers become more evenly distributed in the slurry and in the final membrane structure. This leads to an increase in exposed surface area and the formation of additional or enlarged pores within the membrane. The benefit of such disaggregation is improved ionic diffusion pathways and more homogeneous material properties: a well-disaggregated clay produces a membrane with consistent thickness, fewer weak spots, and enhanced ion transport channels. In practice, complete disaggregation (reducing all bundles to single fibers) may not be necessary or even desired; instead, partial disaggregation is often targeted to open up the structure without losing all fiber-fiber interactions, thus maintaining mechanical cohesion. Overall, controlling the degree of disaggregation is a key aspect of the membrane fabrication process, directly influencing the composite's porosity, strength, and electrochemical performance.

Dispersible means the characteristic of a material or substance to break down and distribute evenly when introduced into a solvent, typically water or an aqueous mixture, without forming stable agglomerates or uneven clusters. In energy storage technologies, especially those involving clay-based membranes or composite formulations, dispersibility is crucial to achieving homogeneity at the microstructural level. When materials disperse properly, each particle or fiber can effectively interact with functional additives, such as zwitterions, ionic liquids, or crosslinkers, thus ensuring consistent ion transport paths and uniform mechanical properties. Moreover, good dispersibility can simplify the downstream manufacturing processes, making it easier to cast, coat, or print membranes with a high degree of consistency and reproducibility. In addition to improving process control, dispersible materials often lend themselves to recycling and ecological disposal methods, as they can be more readily broken down or separated from a composite. This property becomes especially attractive when designing for biodegradability or closed-loop manufacturing, where reusability and minimal environmental impact are prioritized. Factors that influence dispersibility include particle size, surface chemistry, solvent polarity, and processing techniques like ultrasonication or high-shear mixing. Proper surface modifications, such as functionalizing clay particles with zwitterions, can further enhance their compatibility with specific solvents, leading to improved uniformity and performance in the final membrane structure.

Dopant means a substance (often an impurity element or compound in controlled amounts) intentionally introduced into a material to alter its electrical, optical, or structural properties. In electrochemical devices and materials science, dopants are used to tweak conductivity, mechanical strength, or chemical reactivity. Within the scope of this invention, a dopant typically refers to additional cationic species (for example, transition metal ions like Mn²⁺, Fe²⁺, Co²⁺, or Cu²⁺) added to the sepiolite clay slurry. These dopant ions incorporate into or onto the clay structure, potentially exchanging with the clay's native Mg²⁺ or binding to coordination sites, thereby modifying the membrane's properties. For instance, introducing a small fraction of transition metal ions can enhance the composite membrane's ionic conductivity (if those ions participate in redox processes or provide catalytic effects) and can influence mechanical properties or thermal stability. The concept of doping is borrowed from fields like semiconductor physics (where doping controls electrical conductivity), but in the context of a clay membrane, it broadly covers any minor additive meant to improve performance. The dopant level is typically low (often a few weight percent or less) to avoid disrupting the host structure while still imparting noticeable property changes. By carefully selecting and controlling dopants, the inventors tailor the membrane for specialized functionalities (like improved charge transfer or catalytic activity) without compromising its structural integrity or flexibility.

Electrolyte means a medium that contains charged species and enables the flow of ions between the anode and cathode in electrochemical systems like batteries, fuel cells, and supercapacitors. The electrolyte's fundamental role is to conduct ions while inhibiting the passage of electrons, thus maintaining electrical isolation of electrodes and preventing short circuits. Electrolytes can exist in various phases-liquid, gel, or solid—and commonly include salts like lithium hexafluorophosphate (LiPF₆) or ionic liquids in the case of lithium-ion or sodium-ion batteries. Key performance indicators for electrolytes include ionic conductivity, electrochemical stability window, thermal stability, and compatibility with electrode materials. An electrolyte that operates across a wide temperature range and remains chemically stable under demanding cycling conditions extends the operational life and safety of the energy storage device. Formulations that integrate advanced additive chemistries or nanostructured components can further optimize transport properties, suppress unwanted side reactions (like dendrite growth), and improve charge efficiency. Additionally, non-toxicity and environmental sustainability are emerging considerations, driving research into bio-based or low-fluoride electrolytes. The electrolyte is often termed the “lifeblood” of electrochemical devices because it critically influences energy density, power capability, safety, and overall longevity of the system. In the context of this invention, the composite clay membrane can itself retain electrolyte (for example, an ionic liquid) within its pores, effectively blending separator and electrolyte functions to improve ionic transport while maintaining electrical isolation.

Energy Storage Device means a system designed to capture energy from various sources, store it in a stable form, and release it on demand. Battery systems, supercapacitors, and fuel cells are the most common embodiments of electrochemical energy storage devices, each offering distinct advantages in energy density, power output, and cycle life. Factors influencing an energy storage device's performance include electrode materials, electrolytes, membranes, and system architecture. Lithium-ion batteries, for instance, have become ubiquitous due to their relatively high energy density and long cycle life, while supercapacitors excel at delivering rapid bursts of power. Fuel cells are prized for their high efficiency and potential for continuous operation as long as a fuel source is supplied. The choice of device also depends on the application's specific demands-such as portability, cost, operating temperature, or environmental impact. Achieving a balance among these factors requires careful material selection, including the membranes that separate electrodes and facilitate ionic transport. As renewable energy continues to expand, energy storage devices become even more critical for grid stability, load balancing, and decarbonizing transportation. Ongoing research in nanomaterials, polymer chemistry, and solid electrolytes is pushing the boundaries of what these devices can achieve, aiming for higher capacities, lower costs, and a reduced ecological footprint.

Fiber bundles means clusters or aggregates of elongated, thread-like particles that are naturally present in fibrous materials such as sepiolite clay. Sepiolite consists of microscopic fibers or needles that, due to surface forces and entanglements, group together into bundles resembling a packed bunch of fibers. In the pristine (unmodified) clay, these fiber bundles can be tightly interwoven, limiting the clay's accessible surface area and the free volume between fibers. Within the context of this invention, fiber bundles refer to the intertwined sepiolite fibers that the process aims to partially separate or loosen. When a zwitterionic functionalizer like betaine is added, it attaches to the fiber surfaces and helps pry the bundles apart (a phenomenon observed as partial disaggregation of the fibers). This results in a more open structure-often likened to an “anemone-like” configuration where fibers radiate outward with more spacing between them. Such transformation of fiber bundles has significant implications: it increases the membrane's porosity and creates continuous channels for electrolyte infiltration and ion transport, thereby improving the ionic conductivity of the membrane when used as a separator. Fiber bundles also influence the rheology of the clay slurry; well-separated fibers lead to a more uniform suspension that can cast into membranes with consistent thickness. However, some degree of fiber-fiber contact within bundles can contribute to mechanical strength in the dried membrane, so the invention balances the separation of fiber bundles to enhance performance while retaining enough connectivity to preserve structural integrity. Understanding and controlling fiber bundle morphology is therefore crucial in optimizing the composite membrane's synthesis and function.

Fuel Cell means an electrochemical reactor that directly converts the chemical energy contained in a fuel, typically hydrogen or methanol, into electrical energy and heat without combustion. Unlike batteries, which store finite amounts of reactive material, fuel cells can run continuously provided a fuel supply is maintained. This technology involves separate electrodes—an anode where fuel oxidation takes place and a cathode where an oxidant (often oxygen from air) is reduced. The processes are driven by an electrolyte that facilitates ionic conduction but prevents the mixing of fuel and oxidant. The efficiency, power density, and operating temperature of a fuel cell strongly depend on the choice of electrolyte and membrane materials, such as proton exchange membranes (PEMs) or ceramic electrolytes in high-temperature variants like solid oxide fuel cells (SOFCs). Fuel cells are celebrated for their potential to deliver clean energy with minimal carbon emissions, especially when paired with green hydrogen produced via renewable sources. However, challenges remain in cost reduction, stack longevity, and infrastructure for producing and distributing hydrogen. Ongoing research focuses on advanced catalysts, membrane durability, and system-level optimizations to make fuel cells more accessible across applications, from portable electronics and heavy-duty transportation to stationary power generation. In the context of this invention, the separator membrane is crucial in a fuel cell, as it must conduct ions (like protons in a PEM) while separating fuel and oxidant, which underscores the importance of developing robust, ion-conductive membranes such as the disclosed clay composite.

Glass Substrates means solid bases composed primarily of amorphous silica or silicate networks, chosen for their transparency, chemical inertness, and dimensional stability. Used in applications ranging from microelectronics to advanced membrane fabrication, glass substrates offer a stable platform that endures a wide temperature range without significant expansion or deformation. Their smooth, uniform surface can support thin films and coatings, such as clay-based composite membranes, with high precision. This makes glass substrates particularly valuable in research settings where repeatability and minimal contamination are paramount. They can also be chemically treated, patterned, or coated with intermediate layers to influence surface energy and improve adhesion for specialized applications. Despite these advantages, glass can be brittle and must be handled with care to prevent fracture, especially when scaling up to larger dimensions. Advances in glass formulations have yielded variants with enhanced toughness, flexibility, or scratch resistance, broadening potential use cases in next-generation devices. In the context of the present invention, a glass plate can serve as the substrate on which the sepiolite clay slurry is cast and dried. Such use takes advantage of glass's inertness and smoothness to form uniform membranes, and allows the dried membrane to be peeled off easily or utilized directly in a cell. Overall, glass substrates serve as versatile, low-contamination foundations for fabricating high-performance membranes and microstructures, contributing to reproducibility, reliability, and durability in modern technological systems.

Ionic liquid means a salt that is in the liquid state at or near room temperature, typically composed of an organic cation (such as an imidazolium, pyridinium, or ammonium ion) and a complementary anion (such as a fluorinated borate or sulfonylimide). These salts have unusually low melting points due to their asymmetric, bulky ions, which prevent them from easily forming a crystalline solid lattice. As a result, at ambient conditions they exist as stable liquids with essentially no vapor pressure and high ionic conductivity. In the context of the present invention, an ionic liquid (for example, 1-hexyl-3-methylimidazolium bis(trifluoromethylsulfonyl)imide as noted in the specification) is used as an additive to the sepiolite clay slurry before drying. The ionic liquid becomes incorporated into the clay's network of channels and pores upon membrane formation, effectively infusing the composite with a built-in electrolyte. This inclusion significantly enhances the membrane's ability to conduct ions, pushing its ionic conductivity toward values comparable to liquid or gel electrolytes. Moreover, because ionic liquids remain liquid over a wide temperature range and are non-volatile, the resulting membrane can operate in environments that would dry out or overheat conventional liquid electrolytes. The ionic liquid can also plasticize the clay membrane to some extent, improving flexibility while maintaining thermal stability. By integrating an ionic liquid into the clay matrix, the invention creates a composite separator that not only physically separates electrodes but also actively facilitates ion transport, all without the risk of drying out or combusting that is associated with volatile organic electrolytes.

Lithium-intercalation compound means a material, typically used in battery electrodes, that can reversibly host lithium ions within its crystalline structure through an intercalation mechanism. Such compounds have lattice frameworks or layered structures with sites (interstitial spaces) that allow lithium ions (Li+) to insert (intercalate) and extract with minimal structural damage. In practice, lithium-intercalation compounds are most often associated with cathode materials in lithium-ion batteries. Examples include lithium cobalt oxide (LiCoO₂), lithium iron phosphate (LiFePO₄), lithium manganese oxide (LiMn₂O₄ spinel), and various lithium nickel manganese cobalt oxides (LiNixMnyCozO₂ formulations). When a battery charges or discharges, lithium ions shuttle between the anode and the cathode; the intercalation compound at the cathode will take in lithium ions during discharge (when it is being reduced) and release lithium ions during charge (when it is being oxidized). The ability of a lithium-intercalation compound to accommodate lithium without collapsing or significantly changing phase is what gives lithium-ion batteries their rechargeability and long cycle life. In the context of the invention, this term might be used to characterize the type of cathode active material present in an electrochemical cell that uses the disclosed sepiolite clay membrane as a separator. It highlights that the cell's cathode is of the intercalation type (as opposed to other chemistries like conversion electrodes or sulfur electrodes, except where explicitly stated otherwise). The performance (voltage, capacity, and stability) of such a battery is directly tied to the properties of the lithium-intercalation compound, and these materials are continually optimized in the industry for higher energy density and stability. Mentioning the lithium-intercalation compound in the glossary ensures clarity that any reference to a cathode material in the claims pertains to this well-known class of lithium-hosting compounds.

Lithium-ion means a type of rechargeable battery technology that harnesses the movement of lithium ions between two electrodes, typically a graphite-based anode and a metal oxide cathode, all immersed in an electrolyte solution. The continuous shuttling of lithium ions during charge and discharge cycles provides a relatively stable output voltage, high energy density, and a long cycle life when compared to older chemistries like lead-acid or nickel-cadmium. Lithium-ion batteries have achieved widespread adoption in applications ranging from consumer electronics to electric vehicles and large-scale energy storage, primarily due to their favorable balance of performance metrics. However, concerns regarding resource availability, cost, and safety persist. Research efforts focus on improved electrode materials (e.g., silicon-doped graphite anodes, solid-state electrolytes) to enhance specific capacity, reduce reliance on rare or expensive metals, and mitigate thermal runaway risks. Thermal management systems often complement lithium-ion packs to regulate temperature and avoid scenarios that can lead to battery degradation or catastrophic failure. Continuous innovation in advanced manufacturing, recycling, and second-life applications helps maintain lithium-ion technology's prominence in an increasingly electrified and environmentally conscious world. Within the scope of this invention, the advanced clay-based membrane separator is designed to be implemented in lithium-ion cells, contributing to the safety and robustness of the battery by providing a thermally stable, ion-conductive barrier between the anode and cathode without altering the fundamental lithium-ion chemistry.

Membrane means a discrete barrier designed to selectively control the passage of ions, molecules, or particles between two regions, often utilized in electrochemical systems such as batteries, supercapacitors, or fuel cells to physically separate the anode and cathode. The performance of a membrane critically influences ion transport efficiency, internal resistance, and the overall safety of these devices. Membranes can be manufactured from a variety of materials, including polymers, ceramics, composite structures, or clay-based hybrids, each offering distinct advantages in mechanical stability, thermal tolerance, and chemical compatibility. Key characteristics such as pore size distribution, thickness, and chemical functionality determine how effectively a membrane manages ionic flow while blocking electrons and preventing short circuits. In high-performance devices, the membrane must remain stable over extended cycling and under demanding conditions, including rapid charge-discharge cycles or elevated temperatures. Moreover, the membrane can be designed to provide additional functions such as flame retardancy, self-healing, or enhanced mechanical reinforcement. While polymeric membranes are widely used, they may suffer limitations in thermal stability and end-of-life disposal. Emerging research on advanced clay, ceramic, or hybrid membranes aims to address these limitations by combining environmentally benign materials with tailored structural properties that boost device safety and performance. In the present invention, the membrane is a clay-zwitterion composite separator that embodies these principles, offering high ionic conductivity alongside superior thermal and mechanical stability compared to traditional separators.

Metallic Foils means thin sheets of metals such as aluminum, copper, stainless steel, or nickel, employed in electrochemical devices to function as current collectors, electrode substrates, or conductive layers. These foils are fundamental to battery architecture, where they serve both mechanical and electrical roles by supporting active materials and facilitating efficient electron transfer. The choice of metal type and foil thickness is influenced by considerations like conductivity, corrosion resistance, thermal management, weight, and cost. For instance, aluminum foil is commonly paired with cathode materials in lithium-ion batteries, while copper foil is often used for anodes. Advances in coating technologies and surface treatments can enhance adhesion between the foil and electrode materials, prevent surface oxidation, and reduce interfacial resistance. In some cases, metallic foils are patterned or etched to increase surface area, thereby improving the electrode's capacity and rate performance. Balancing mechanical ductility with robustness is also important, as foils need to withstand processes like calendering and repeated cycling. Their role in overall device reliability and efficiency cannot be understated, and ongoing improvements in foil manufacturing and finishing aim to optimize these thin metal layers for next-generation energy storage and conversion systems. In this invention, a metallic foil can additionally serve as the substrate onto which the clay slurry is cast during membrane fabrication, effectively merging the separator production with a built-in current collector support for later assembly into a battery or supercapacitor.

Polymeric Films means thin, continuous layers of synthetic or naturally derived polymers utilized in numerous industrial applications, including packaging, insulation, and separation. In electrochemical energy storage devices, polymeric films often serve as separators or protective coatings, thanks to their flexibility, processability, and chemical inertness. Common materials include polyethylene, polypropylene, and fluorinated polymers, each capable of forming microporous structures to facilitate ionic transport while maintaining electronic insulation between electrodes. Polymeric films can be manufactured through methods like extrusion, solvent casting, or stretching, enabling precise control over thickness, porosity, and mechanical properties. Despite their widespread use, these films have inherent limitations related to thermal stability, since many polymers begin to melt or deform at moderately elevated temperatures, posing risks in high-power or high-temperature applications. Researchers are thus exploring high-performance polymers or blends reinforced with ceramic, clay, or other fillers to enhance mechanical strength, flame retardancy, and electrolyte compatibility. The lifecycle impact of polymeric films is another growing concern, spurring interest in biodegradable or recyclable polymer systems that minimize environmental harm when devices are decommissioned. In the context of the current invention, polymeric films represent both an option for the substrate (e.g., a polymer film onto which the clay slurry can be cast) and a benchmark for separator performance. The disclosed clay-zwitterion membrane aims to offer improved thermal resistance and safety compared to conventional polymeric film separators, while still providing the thin, flexible qualities that make polymer films attractive in battery assemblies.

Pores means the small voids, channels, or openings within a material through which fluids or ions can move. Pores can range widely in size and shape, from tiny nanometer-scale cavities (micropores) to larger tunnels or gaps (mesopores and macropores), and they collectively determine the porosity of a structure. In the context of the sepiolite clay composite membranes of this invention, pores refer to the intrinsic channels in the clay and the inter-fiber gaps that form within the membrane. Sepiolite inherently contains a network of nano-sized channels running along its fibrous crystals, giving it a significant surface area and the ability to absorb or adsorb molecules. When sepiolite fibers aggregate into bundles, some of these pores become less accessible; conversely, when the clay is functionalized with additives like betaine and/or combined with an ionic liquid, the fiber bundles spread apart, generating additional void spaces. Empirical data in the disclosure indicate that the average pore diameter in a sepiolite membrane can increase from roughly 3-4 nm in the unmodified state to on the order of 10-25 nm after zwitterion treatment, illustrating the creation of mesoporous channels. These pores are critical for the membrane's function as a separator in energy devices: they allow liquid electrolyte and ions to percolate through, enabling ionic conductivity between the anode and cathode while still preventing direct electrical contact. A well-balanced pore structure ensures high ionic flux (for power capability) and adequate electrolyte retention, yet avoids large pathways that could permit dendrite growth or mechanical failure. Controlling pore size distribution and porosity during membrane fabrication is thus essential to achieve a separator that is both safe and high-performing.

Separator means a critical component in electrochemical devices-such as rechargeable batteries, supercapacitors, and fuel cells-dedicated to electrically isolating the anode and cathode while permitting ionic conduction. By preventing direct electron flow between electrodes, the separator preserves device stability and curtails risks of internal short circuits. The ideal separator features high ionic conductivity, robust mechanical properties, chemical inertness, and compatibility with a broad range of electrolyte chemistries. Polymeric materials like polyethylene or polypropylene are widely utilized, but advanced compositions may incorporate clay, ceramic, or inorganic fillers to bolster thermal resistance and structural integrity. Additionally, the separator's porosity and pore size distribution are pivotal, as they govern the ionic flux and internal impedance of the battery or device. Excessively large pores may promote dendrite formation, especially in lithium-based systems, while exceedingly small or clogged pores can impede ion diffusion, lowering power output. The separator's thickness must also be optimized: thinner membranes reduce ionic resistance but may compromise mechanical durability. High-performance designs sometimes integrate multilayer structures or functional coatings to create safety features, such as shutdown layers that close pores under excessive heat. The separator's role, therefore, is multifaceted and integral to achieving the delicate balance of safety, performance, and longevity in energy storage systems. In this invention, the free-standing sepiolite clay membrane acts as the separator, providing the necessary electrical isolation along with improved thermal stability and flame resistance compared to conventional polymer separators.

Sepiolite Clay means a naturally occurring magnesium silicate mineral with a distinctive fibrous morphology and an intricate channel-based structure that affords high surface area, porosity, and significant cation-exchange capacity. This rod-like, fibrous architecture sets sepiolite apart from many other clays, enabling it to incorporate functional agents or dopants effectively. The interplay between its surface silanol groups and various chemical species—from ionic liquids to zwitterions-facilitates the development of composite membranes with enhanced mechanical strength and ionic conductivity. Sepiolite's inherent thermal stability also allows it to endure elevated operating temperatures, making it an attractive candidate in applications such as battery separators, catalysis, or filtration. Abundant and comparatively low-cost, sepiolite stands out as an environmentally appealing option, supporting the push toward green engineering solutions. Its ability to immobilize and entrap specific molecules makes it conducive for tailoring structural or chemical properties, such as pore size and surface functionality, during processing steps like slurry preparation or vacuum drying. Sepiolite-based materials offer improved safety features and extended lifespans in energy systems, all while benefiting from a straightforward synthesis route and wide global availability. In this invention, sepiolite is the base material of the composite membrane, chosen for its exceptional heat tolerance and ability to be chemically modified (via zwitterion attachment and doping) to achieve superior separator performance compared to conventional polymer-based materials.

Slurry means a flowable mixture in which solid particles are suspended in a liquid phase, forming a thick, often mud-like fluid. In general, industrial and chemical practice, a slurry allows solid materials to be handled, transported, or processed in a liquid-like manner. Within the context of this invention, the term slurry typically refers to the sepiolite clay suspension prepared as an initial step in membrane fabrication. This slurry is created by dispersing fine sepiolite clay particles (or fibers) in a solvent, usually deionized water, sometimes with additional additives like zwitterions (e.g., betaine), ionic liquids, or other dopants. The goal is to achieve a homogeneous mixture where the clay is well-dispersed, meaning the fibers or particles are separated and evenly distributed throughout the liquid. The characteristics of the slurry-such as its viscosity, stability (resistance to settling), and uniformity—are crucial because they directly influence the quality of the cast membrane. A well-prepared slurry will cast into a membrane with uniform thickness and composition, whereas a poorly dispersed slurry could lead to defects or uneven regions in the dried film. Processing techniques like stirring, ball milling, or ultrasonication may be employed to produce a stable slurry. Once the slurry is ready, it is typically applied onto a chosen substrate (which could be a metallic foil, polymer film, glass plate, or ceramic surface) as per the invention's method, and then dried (often under ambient temperature and vacuum conditions) to form the solid composite membrane. Thus, “slurry” in this context is essentially the precursor mixture that contains all necessary components in liquid form, from which the final membrane will be formed after solvent removal.

Sodium-ion means a class of rechargeable battery technology analogous to lithium-ion systems but employing sodium ions for charge storage and release. Owing to sodium's broader abundance and potentially lower raw material costs, sodium-ion batteries have drawn interest as more sustainable, cost-effective alternatives for large-scale energy storage, like stationary grid applications. However, sodium's larger ionic radius compared to lithium can pose challenges in achieving comparable energy densities and cycle lifetimes. Research into suitable cathode materials-such as layered oxides or polyanionic compounds-alongside stable anodes (which may be carbon-based or alloy-forming) is ongoing to enhance performance metrics like capacity, rate capability, and cyclability. As with lithium-ion cells, the internal architecture of a sodium-ion battery includes a separator, electrolyte, an anode, and a cathode, with each component carefully optimized for Na⁺ insertion and extraction. Thermal management and safety considerations also apply, though sodium-ion systems may benefit from a reduced risk of thermal runaway under certain configurations. Ultimately, sodium-ion technology represents a promising area of development for mitigating supply chain constraints and geopolitical tensions linked to lithium resources, while still delivering robust energy storage solutions that dovetail with the expansion of renewable energy usage. Within the scope of this invention, the same clay-zwitterion composite membrane separator developed for lithium-ion cells can be adapted to sodium-ion batteries, leveraging its ion-conductive pathways and thermal resilience to handle the demands of Na⁺ transport and safety requirements in these emerging systems.

Substrate means a foundational layer or support material on which another material, like a composite membrane or thin film, is deposited or coated. Substrates can be composed of a variety of substances, including metals, polymers, ceramics, or glass, each offering distinct advantages in terms of mechanical strength, heat tolerance, and chemical compatibility. In the assembly of energy storage and conversion devices, substrates act as mechanical stabilizers and can also serve as current collectors or diffusion barriers. Their surface chemistry, porosity, and topography can be carefully engineered or modified through treatments like plasma etching, polishing, or functional coatings to optimize adhesion and interfacial interactions. The choice of substrate affects factors such as the uniformity of a deposited membrane, the ease of subsequent processing steps (like drying or sintering), and the device's overall thermal management. In certain designs, flexible polymeric substrates enable bendable electronics, while rigid ceramic or metallic substrates might be preferred for high-temperature or high-pressure operations. Advancements in substrate technology continue to impact the performance and manufacturability of cutting-edge devices, making substrate selection a central consideration in the broader field of materials and process engineering. In this invention, the substrate (for example, a metal foil, polymer film, glass plate, or ceramic surface) is the base on which the clay slurry is cast and dried, providing support during membrane formation and potentially serving as part of the end-use device (e.g., as a built-in current collector or structural support).

Supercapacitor means a high-capacity electrochemical capacitor that stores and releases energy through mechanisms such as electric double-layer capacitance (EDLC) or pseudocapacitance, enabling extremely rapid charge-discharge cycles compared to conventional batteries. Supercapacitors are frequently employed in applications needing short bursts of high power-like regenerative braking systems, backup power supplies, and peak shaving in electrical grids. Their key components typically include electrodes coated with high-surface-area materials, such as activated carbon, carbon nanotubes, or graphene, which maximize charge storage via surface interactions. An electrolyte mediates ion transport between electrodes, while a separator averts electrical short circuits yet permits ionic conduction. Although supercapacitors excel in delivering high power density and extended cycle lifetimes, they usually offer lower energy density than rechargeable batteries. Research on hybrid designs aims to blend battery-like faradaic processes with capacitor-like double-layer mechanisms to push energy density limits. Attention is also directed at refining cost-effectiveness, operational voltages, and safety features, especially in large-scale energy management contexts. Consequently, supercapacitors occupy a vital role in diverse applications that demand both flexibility and reliability, bridging gaps in performance where neither traditional dielectric capacitors nor batteries may be optimal. Within this invention, the sepiolite clay-based membrane serves as a high-performance separator for supercapacitors as well, leveraging its superior ionic conductivity and thermal stability to ensure safe, efficient operation during rapid charging and discharging cycles.

Surface Silanol Site means a reactive functional group located on the surface of a silicate mineral, composed of a silicon atom bonded to a hydroxyl group (Si—OH). In minerals like sepiolite clay, these silanol groups are abundant at the edges of the fibrous crystal structure and along the internal channels that terminate at the surface. Such sites are chemically significant because they can form hydrogen bonds and can interact with various chemical species. In the context of the invention, surface silanol sites are the attachment points on the clay where zwitterionic compounds (like betaine) or other functional molecules bond during the functionalization process. When a zwitterion is added to the clay slurry, the negatively charged part of the zwitterion (such as a carboxylate group) can interact with the silanol's hydrogen, while the positively charged part might interact with negatively charged oxygen atoms, effectively anchoring the molecule onto the clay's surface. This bonding to the silanol sites results in the organic modifier coating or grafting onto the clay fiber surfaces. By occupying surface silanol sites with these additives, the clay's surface chemistry is altered: it becomes more organophilic and acquires fixed positive/negative sites from the zwitterion, which in turn improves compatibility with electrolytes and dispersion in the slurry. Additionally, silanol sites can participate in ion exchange or coordinate with introduced metal cations if transition metal doping is employed. The term “surface silanol site” underlines the mechanism by which the clay is chemically linked with functional groups, a key to how the composite membrane is engineered at the molecular level to achieve enhanced ionic conductivity and stability. Essentially, these sites are the bridges between the inorganic clay structure and the organic or ionic modifiers that together form the functional composite.

Transition metal means any element from the central block of the periodic table (the d-block, typically Groups 3 through 12) which is characterized by its ability to form various oxidation states and to bond with a variety of ligands. Common examples include iron (Fe), copper (Cu), cobalt (Co), nickel (Ni), manganese (Mn), among others. Transition metals often have unpaired d-electrons, leading to properties like catalytic activity, electrical conductivity enhancements, and magnetic behavior. In the context of the invention, transition metal ions (such as Mn²⁺, Fe²⁺, Co²⁺, or Cu²⁺) are used as dopants introduced into the sepiolite clay slurry or structure. By incorporating small amounts of these metal cations into the clay matrix (for instance, by ion exchange replacing some of sepiolite's native magnesium or by adsorption onto the clay's surfaces), the composite membrane can be endowed with modified electrical or electrochemical characteristics. For example, the presence of certain transition metals could facilitate redox reactions within the membrane or interact beneficially with lithium or sodium ions, potentially suppressing detrimental processes like dendrite formation in batteries. Transition metal doping might also slightly affect the clay's microstructure or thermal stability, potentially enhancing mechanical stiffness or heat resistance due to the formation of new ionic bridges within the clay. However, the amount of transition metal introduced is kept low to preserve the membrane's flexibility and to avoid adding significant weight or cost. The glossary inclusion of “transition metal” highlights that the invention contemplates using these elements to fine-tune the membrane's properties; it underscores a broad category of functional additives distinct from the organic zwitterions and is integral when aiming for specific improvements (like higher ionic conductivity or catalytic functionality) in advanced electrochemical energy storage devices.

Vacuum Conditions means a controlled environment under reduced atmospheric pressure, achieved by removing air and other gases. This is vital in numerous industrial and laboratory processes, including the drying or curing of composite membranes, because it curbs oxidative reactions and inhibits the introduction of contaminants that might degrade structural or chemical integrity. By eliminating residual moisture more effectively than ambient drying, vacuum conditions can reduce bubble formation and enhance the uniformity and density of cast films or coated layers. In energy storage device manufacturing, vacuum processing frequently appears in steps like solvent removal, electrode fabrication, or the conditioning of powders and electrolytes. This environment also assists in controlling evaporation rates, promoting desirable film morphologies and aiding in the infiltration of functional agents like ionic liquids into porous scaffolds. Vacuum levels can vary from low (a few millibars) to ultrahigh (below 10⁻⁹ millibar), depending on the requirements for gas purity and process sensitivity. Achieving consistent and reproducible vacuum conditions often necessitates specialized equipment such as vacuum pumps, sealed chambers, and monitoring gauges. In the context of this invention's method, the clay slurry is dried under vacuum conditions (at ambient temperature) to ensure thorough solvent removal without thermal decomposition of the zwitterionic additives, resulting in a uniform membrane free of trapped bubbles or oxidative damage. Overall, vacuum conditions play a critical role in refining material qualities and elevating the reliability of advanced manufacturing processes for high-performance electrochemical systems.

Zwitterion means a molecular entity or compound that incorporates both positively charged and negatively charged functional groups in its chemical structure, but remains overall electrically neutral. This dual charge configuration fosters unique interactions with surfaces, solvents, and other charged species, making zwitterions highly relevant in applications like membrane functionalization, colloidal stabilization, and biomimetic interfaces. In clay-based systems, zwitterions can anchor onto the silanol groups present on mineral surfaces, improving properties such as compatibility, dispersibility, and ionic conductivity. Because they balance acidic and basic groups internally, zwitterions can exhibit pH-stable characteristics, minimizing environmental or operational sensitivities in processes that hinge on ionic conduction. Examples include amino acids-like betaine, alanine, or arginine-frequently employed to tailor electrostatic interactions or enhance mechanical coherence in clay-based membranes. In addition to energy storage, zwitterion-derived materials find uses in fields such as drug delivery and antifouling coatings, where non-covalent interactions are key. In the context of this invention, the zwitterions of interest (including betaine and certain amino acids) are utilized to functionalize sepiolite clay surfaces, leveraging their dual charges to form stable, adaptive interfacial layers that markedly boost the composite membrane's ionic transport capabilities and structural cohesion. The ongoing study of zwitterionic chemistries aims to capitalize on their capacity to form such stable, adaptive interfaces, broadening the scope for advanced composite materials with high functionality and stability.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A method for synthesizing a zwitterion-functionalized sepiolite clay composite membrane, comprising:
a. dispersing sepiolite clay in water to form a sepiolite clay slurry;
b. functionalizing the sepiolite clay by adding at least one zwitterionic compound to the slurry, whereby the zwitterionic compound attaches to surface silanol sites of the clay and partially disaggregates sepiolite fiber bundles;
c. applying the functionalized sepiolite clay slurry onto a substrate; and
d. drying the applied slurry under vacuum to yield a self-supporting composite membrane.

2. The method of claim 1, wherein the zwitterionic compound is betaine (trimethylglycine).

3. The method of claim 1, wherein the zwitterionic compound is selected from amino acids consisting of alanine, arginine, proline, and valine.

4. The method of claim 1, further comprising adding an ionic liquid to the sepiolite clay slurry before the drying step, such that the ionic liquid becomes incorporated within pores or channels of the sepiolite clay upon drying.

5. The method of claim 1, further comprising introducing one or more transition metal cations into the sepiolite clay slurry prior to drying, the cations being selected from the group consisting of Mn²⁺, Fe²⁺, Co²⁺, and Cu²⁺, thereby doping the composite membrane with metal ions.

6. The method of claim 1, wherein dispersing the sepiolite clay includes subjecting the slurry to ultrasonic agitation to promote homogeneous mixing of the clay and the zwitterionic compound.

7. The method of claim 1, wherein the substrate onto which the slurry is applied is selected from the group consisting of a metallic foil, a polymer film, a glass plate, and a ceramic surface.

8. The method of claim 1, wherein the slurry is dried at approximately ambient temperature under vacuum conditions, such that the removal of solvent occurs without thermal decomposition of the zwitterionic compound.

9. A zwitterion-functionalized sepiolite clay composite membrane, comprising:
a. sepiolite clay in the form of an entangled fibrous matrix; and
b. a plurality of zwitterionic organic molecules bonded to surfaces of the sepiolite clay fibers,
c, wherein the composite membrane is a free-standing, flexible film that is substantially free of polymeric binders or carbonaceous fillers.

10. The composite membrane of claim 9, wherein the zwitterionic organic molecules comprise betaine.

11. The composite membrane of claim 9, wherein the zwitterionic organic molecules comprise one or more amino acids selected from alanine, arginine, proline, and valine.

12. The composite membrane of claim 9, further comprising an ionic liquid distributed within the clay matrix, the ionic liquid being retained in pores or channels of the sepiolite clay.

13. The composite membrane of claim 12, wherein the ionic liquid is 1-hexyl-3-methylimidazolium bis(trifluoromethylsulfonyl)imide.

14. The composite membrane of claim 9, further comprising transition metal ions selected from Mn, Fe, Co, or Cu incorporated in the sepiolite clay structure as dopants.

15. The composite membrane of claim 9, wherein the membrane has an average pore diameter of at least about 10 nanometers, as a result of the zwitterionic functionalization disaggregating clay fiber bundles.

16. The composite membrane of claim 15 wherein the average pore diameter is between 10 and 25 nanometers.

17. An electrochemical energy storage device comprising:
a. at least one anode;
b. at least one cathode;
c. an electrolyte; and
d. a separator disposed between the anode and cathode, wherein the separator comprises a zwitterion-functionalized sepiolite clay composite membrane configured to permit ionic conduction between the anode and cathode while electrically insulating them.

18. The energy storage device of claim 17, wherein the device is selected from the group consisting of a lithium-ion battery, a sodium-ion battery, an electrical double-layer supercapacitor, and a fuel cell.

19. The energy storage device of claim 17, wherein the separator comprises a betaine-functionalized sepiolite clay membrane in which betaine molecules are bonded to the sepiolite clay fibers.

20. The energy storage device of claim 17, wherein the anode is composed of lithium metal, thereby defining a lithium metal battery configuration.

21. The energy storage device of claim 17, wherein the anode comprises graphite and the cathode comprises a lithium transition-metal oxide active material, thereby defining a lithium-ion battery configuration.

22. The energy storage device of claim 17, wherein the electrolyte comprises a lithium salt dissolved in a non-aqueous organic solvent, the lithium salt being selected from LiPF₆, LiClO4, or LiFSI in a carbonate or ether-based solvent mixture.

23. The energy storage device of claim 17, wherein the separator is water-dispersible to facilitate end-of-life recycling or disposal of the device, such that upon contact with water the separator at least partially dissolves or disintegrates.

24. A method of manufacturing an electrochemical energy storage device, comprising:
a. providing an anode and a cathode;
b. positioning a zwitterion-functionalized sepiolite clay composite membrane as a separator between the anode and cathode;
c. introducing an electrolyte to the anode, cathode, and separator; and
d. sealing the anode, cathode, and separator together in a cell housing to form a functional electrochemical device.

25. The method of claim 24, wherein the anode is a lithium metal anode and the cathode comprises a lithium-intercalation compound or a sulfur composite, thereby assembling a lithium metal battery.

26. The method of claim 24, wherein the electrochemical energy storage device is a lithium-ion battery, and introducing the electrolyte comprises filling the assembled anode, cathode, and separator with a non-aqueous liquid electrolyte containing a lithium salt.

27. The method of claim 24, further comprising pre-soaking the zwitterion-functionalized sepiolite clay composite membrane with the electrolyte prior to positioning it between the anode and cathode, so as to ensure thorough wetting of the separator.

28. The method of claim 24, wherein providing the anode and cathode comprises winding the anode, separator, and cathode together in a cylindrical configuration for insertion into a cylindrical cell housing, or stacking the anode, separator, and cathode in layers for insertion into a pouch cell housing.
